(19) United States
(12) Patent Application Publication
(10) Pub. No.: US 2020/0034932 A1
(43) Pub. Date: Jan. 30, 2020

(54) SYSTEM FOR ESCALATING OVERALL INSURANCE EARNING RATE WITH VARIABLE INSURANCE

(71) Applicant: Soo Seong CHOI, Seoul (KR)

(72) Inventor: Soo Seong CHOI, Seoul (KR)

(21) Appl. No.: 16/143,806

(22) Filed: Sep. 27, 2018

(30) Foreign Application Priority Data
Jul. 25, 2018 (KR) 10-2018-0086555
Aug. 2, 2018 (KR) 10-2018-0090399

(51) Int. Cl. G06Q 40/08; G06Q 40/06; G06Q 40/02

(52) U.S. Cl. CPC G06Q 40/08; G06Q 40/02; G06Q 40/06

(57) ABSTRACT

Provided is a system for escalating an overall insurance earning rate with variable insurance. The system includes a collector configured to collect insurance information of a policy holder who has a plurality of insurance products, including at least one variable insurance product, and wants to live on annuities through interim payments, an annuity calculator configured to calculate annual earning rates of each insurance product using the collected insurance information and calculate possible annuity receipts based on the earning rates, and a sequential arranger configured to sequentially arrange annuities in a manner in which an insurance product with the lowest earning rate among the insurance products whose earning rates have been calculated is put into annuity finances every year starting from an annuity commencement until an annuity end and other insurance products are left untouched during the corresponding time period.

### CROSS-REFERENCE TO RELATED APPLICATION

This application claims priority to and the benefit of Korean Patent Application No. 10-2018-0086555, filed on Jul. 25, 2018 and Korean Patent Application No. 10-2018-0090399, filed on Aug. 2, 2018, the disclosure of which is incorporated herein by reference in its entirety.

### BACKGROUND

### 1. Field of the Invention

The present invention relates to an insurance and annuity technology, and more particularly, to a system for escalating an overall insurance earning rate with variable insurance.

### 2. Discussion of Related Art

Variable insurance is an insurance product in which a part of premium paid by policy holders is put into a fund for management and the investment return is distributed to the policy holders depending on the fund performance. Variable insurance has been developed and sold on the basis of a theory that predicted guarantees or annuity receipts may be increased, and purchases of variable insurance are drastically increasing in this era of low interest rates. As shown in examples in other countries, variable insurance is a major insurance product which will be continuously sold in the future.

Variable insurance products include annuity insurance, and a policy holder having variable insurance may transfer to an annuity. However, in the case of a conversion into an annuity, an applied interest rate is 0.5%, 1%, or the like, which is relatively low. It is possible to expect a few cases in which the earning rate of variable insurance will be remarkably increased during tens of years of an annuity period from an annuity commencement date to an annuity end date. Although people purchase variable insurance due to the possibility of a high profit which may be achieved someday, it is too bad to not only lose an opportunity for the probability but to also transfer to an annuity at a fixed low interest rate and start living on the annuity.

### SUMMARY OF THE INVENTION

The present invention is directed to providing a system and method for escalating an overall insurance earning rate with variable insurance so that a customer may be attracted to variable insurance even when an earning rate of the variable insurance is 0%.

According to an aspect of the present invention, there is provided a system for escalating an overall insurance earning rate with variable insurance, the system including: a collector configured to collect insurance information of a policy holder who has a plurality of insurance products, including at least one variable insurance product, and wants to live on annuities through interim payments; an annuity calculator configured to calculate annual earning rates of each insurance product using the collected insurance information and calculate possible annuity receipts based on the earning rates; and a sequential arranger configured to sequentially arrange annuities in a manner in which an insurance product with the lowest earning rate among the insurance products whose earning rates have been calculated is put into annuity finances every year starting from an annuity commencement until an annuity end and other insurance products are left untouched during the corresponding time period.

The sequential arranger may compare earning rates every year regardless of whether the insurance products are fixed-interest insurance or variable insurance and arrange the annuities so that a changeable insurance product with the lowest earning rate is put into annuity finances every year, and the variable insurance product may perform a variable function together with an overall insurance earning rate escalating function of improving overall insurance efficiency every year until the annuity end by putting the variable insurance product itself or another insurance product into annuity finances.

When an insurance product is fixed-interest insurance, the annuity calculator may calculate an average of the lowest interest rate and a disclosed interest rate of the corresponding year as an annuity earning rate. When an insurance product is variable insurance, the annuity calculator may calculate an expected annuity commencement earning rate by averaging interest rates of a time period between a payment end and the annuity commencement of the policy holder and calculate an expected annuity earning rate of a year from a second year after the annuity commencement according to whether an interim payment has been made in the corresponding year. The annuity calculator may calculate equal annuity receipts every year after the annuity commencement in consideration of a calculated earning rate of each insurance product.

The annuity calculator may calculate the expected annuity commencement earning rate of the variable insurance using an expression

$${\frac{am}{ap}}^{( \frac{1}{a 2 - a 1} )} - 1$$

(where ap is a total amount of payments, am is a cancellation refund of a year immediately before the annuity commencement, a1 is a payment end age, and a2 is an annuity commencement age) and put the calculated expected annuity commencement earning rate into a variable insurance earning rate of a first year after the annuity commencement. The sequential arranger may cause an interim payment to be made from an insurance product with the lowest earning rate and accumulate principals and interests of other products at the corresponding interest rates during one year.

From the second year after the annuity commencement, the annuity calculator may calculate an earning rate of a variable insurance product from which no interim payment has been made in the corresponding year using an expression (a/b)−1 and may calculate an earning rate of a variable insurance product from which any interim payment has been made in the corresponding year using an expression ((a+p)/b)−1. Here, a may be a cancellation refund reported by an insurance company at the end of a last year, b may be a cancellation refund reported by the insurance company at the end of a year before last year, and p may be the amount of interim payments. Every year from the second year after the annuity commencement, the sequential arranger may cause an interim payment to be made from an insurance product with the lowest earning rate and accumulate principals and interests of other products at the corresponding interest rates during one year.

When at least one of an earning rate, the amount of interim payments, and remaining annuity finances is changed, the annuity calculator may recalculate new equal annuity receipts suitable for changed remaining finances every year.

The sequential arranger may determine, when there is an insurance product whose remainder is less than an annuity amount for one year during a sequential arrangement operation, whether the insurance product is fixed-interest insurance or variable insurance, may add the remainder to another insurance product when the insurance product is fixed-interest insurance, and may sequentially arrange other insurance products and add the remainder to another insurance product for settlement at the annuity end when the insurance product is variable insurance.

The system for escalating an overall insurance earning rate with variable insurance may further include an annuity recalculator configured to recalculate additional annuity receipts so that a final remainder of a sequential arrangement operation may be additionally received as annuities. The annuity recalculator may generate a comparative group whose annuity and remainder are a1 and x1 respectively, for comparison with an existing group whose remainder and annuity are x, which is the final remainder left behind in the sequential arrangement operation, and a respectively, separately calculate an annuity movement distance, a remainder movement distance, a remainder movement distance per annuity movement distance p, an annuity movement distance q by which the comparative-group annuity a1 additionally moves so that the comparative-group remainder x1 becomes 0, and a comparative-group annuity a2 for causing the comparative-group remainder x1 to be 0, and calculate annuity receipts that may be additionally received in a manner in which the comparative-group annuity a2 is input to a position of the comparative-group annuity a1 and circulates. Here, the annuity movement distance=the comparative-group annuity a1−the existing-group annuity a, the remainder movement distance=the comparative-group remainder x1−the existing-group remainder x, the remainder movement distance per annuity movement distance p=(x1−x)/(a1−a), the annuity movement distance q by which the comparative-group annuity a1 additionally moves so that the comparative-group remainder x1 becomes 0=the comparative-group remainder x1/the remainder movement distance per annuity movement distance p, and a corrected annuity a1(a2), which may cause the comparative-group remainder x1 to be 0, equals a1+q.

According to another aspect of the present invention, there is provided an annuity calculation method for escalating an overall insurance earning rate with variable insurance, the method including: collecting insurance information of a policy holder who has a plurality of insurance products, including at least one variable insurance product, and wants to live on annuities through interim payments; calculating annual earning rates of each insurance product using the collected insurance information and calculating possible annuity receipts based on the earning rates; and sequentially arranging annuities in a manner in which an insurance product with the lowest earning rate among the insurance products whose earning rates have been calculated is put into annuity finances every year starting from an annuity commencement until an annuity end and other insurance products are left untouched during the corresponding time period.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram showing a configuration of a system for escalating an overall insurance earning rate with variable insurance (referred to as “escalating system” below) according to an exemplary embodiment of the present invention;

FIG. 2 is a block diagram showing a detailed configuration of a controller of FIG. 1 according to an exemplary embodiment of the present invention;

FIG. 3 shows an example of annuity receipts that a policy holder may receive in a general manner when the policy holder lives on annuities with a plurality of insurance products;

FIG. 4 shows an example of annuity receipts that may be received in a sequential annuity calculation method according to an exemplary embodiment of the present invention;

FIGS. 5 and 6 are program screens showing that when a policy holder lives on annuities with a plurality of insurance products, including at least one variable insurance product, it is possible to receive optimal annuities through an annuity calculation program according to an exemplary embodiment of the present invention;

FIGS. 7 to 19 illustrate an annuity calculation program that tells how much annuity may be additionally obtained from a remainder with a sequential annuity arrangement according to an exemplary embodiment of the present invention in comparison with a general simultaneous annuity conversion method;

FIG. 20 shows an all-around annuity calculation program for calculating new stable equal annuity amounts (interim payments) in response to an environmental change according to an exemplary embodiment of the present invention;

FIG. 21 shows a calculation method of an annuity calculation program according to an exemplary embodiment of the present invention;

FIG. 22 shows an example of verification of the annuity calculation program of FIG. 21 according to an exemplary embodiment of the present invention;

FIG. 23 shows a policy holder's two insurance products that are joined together to illustrate the principle of escalating an overall insurance earning rate with variable insurance according to an exemplary embodiment of the present invention;

FIG. 24 shows possible annuity receipts when annuities are received in a general method in the exemplary embodiment of FIG. 23;

FIG. 25 shows possible annuity receipts when annuities are received in a sequential method in the exemplary embodiment of FIG. 23;

FIG. 26 shows possible annuity receipts when annuities are received in the general method when a high profit is made from variable insurance;

FIG. 27 shows a remainder when annuities are received in the sequential method in the example of FIG. 26 according to an exemplary embodiment of the present invention;

FIG. 28 shows a case of increasing annuity receipts in the situation of FIG. 27;

FIG. 29 shows an example of insurance products joined together through the all-around annuity calculation program of FIG. 24 as a preparatory process according to an exemplary embodiment of the present invention;

FIG. 30 shows an example of user inputs to an annuity calculation program for escalating an overall insurance earning rate according to an exemplary embodiment of the present invention;

FIG. 31 illustrates the annuity calculation method for escalating an overall insurance earning rate according to an exemplary embodiment of the present invention;

FIGS. 32 and 33 show annuity calculation screens of the annuity calculation program for escalating a whole insurance earning rate according to an exemplary embodiment of the present invention;

FIGS. 34 and 35 show program screens illustrating a remainder processing method of the annuity calculation program for escalating a whole insurance earning rate according to an exemplary embodiment of the present invention;

FIG. 36 is a flowchart showing a process of escalating a whole insurance earning rate with variable insurance according to an exemplary embodiment of the present invention;

FIG. 37 is a diagram showing a sequential arrangement process of FIG. 36 according to an exemplary embodiment of the present invention; and

FIG. 38 is a flowchart showing a process of recalculating additional annuity receipts according to an exemplary embodiment of the present invention so that a final remainder left behind sequential arrangement may be additionally received as annuities.

### DETAILED DESCRIPTION OF EXEMPLARY EMBODIMENTS

Advantages and features of the present invention and a method of achieving the same will clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. Throughout the drawings, like reference numbers refer to like elements.

In the following description, detailed descriptions of well-known functions or configurations will be omitted when it is determined that the detailed descriptions unnecessarily obscure the gist of the present invention. The terms used in the following description are terms defined in consideration of functionality in exemplary embodiments of the present invention and may vary depending on an intention of a user or an operator, a practice, or the like. Therefore, definitions of terms used herein should be made based on content throughout the specification.

Each block of the appended block diagrams and flowcharts and combinations thereof may be implemented by computer program instructions (an execution engine). These computer program instructions may be provided to a processor of a general-purpose computer, a special-purpose computer, or another programmable data processing apparatus so that the instructions, which are executed via the processor of the computer or the other programmable data processing apparatus, create a means for implementing the functions specified in each block of the block diagrams or flowcharts.

These computer program instructions may also be stored in a computer-us able or computer-readable memory that may direct a computer or another programmable data processing apparatus to function in a particular manner so that the instructions stored in the computer-usable or computer-readable memory may produce an article of manufacture including instructions that implement the functions specified in each block of the block diagrams or flowcharts.

The computer program instructions may also be loaded onto a computer or another programmable data processing apparatus. Therefore, a series of operations may be performed on the computer or the other programmable apparatus to produce a computer-implemented process so that the instructions, which are executed on the computer or the other programmable data processing apparatus, may provide operations for implementing functions specified in each block of the block diagrams or flowcharts.

Also, each block or each operation may represent a portion of a module, a segment, or code which includes one or more executable instructions for implementing the specified logical functions. It should also be noted that in some alternative embodiments, the functions noted in the blocks or operations may occur out of the order. For example, two blocks or operations shown in succession may, in fact, be executed substantially concurrently, or the blocks or operations may sometimes be executed in the reverse order of the corresponding functions as necessary.

Hereinafter, exemplary embodiments of the present invention will be described in detail with reference to the accompanying drawings. However, the present invention is not limited to the embodiments described herein and may be embodied in many different forms. These embodiments of the present invention are provided to fully convey the scope of the invention to those of ordinary skill in the art to which the present invention pertains.

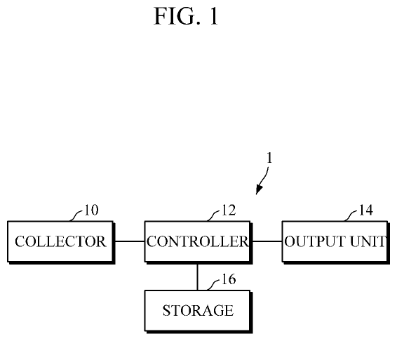

FIG. 1 is a block diagram showing a configuration of a system for escalating an overall insurance earning rate with variable insurance (referred to as “escalating system” below) according to an exemplary embodiment of the present invention.

The present invention targets policy holders who want to live on annuities with interim payments every year. Here, insurance applied to the present invention includes variable insurance as well as fixed-interest insurance. In the escalating system 1 according to an exemplary embodiment of the present invention, the volatility of earning rate of variable insurance and a sequential function are combined together to create a synergy so that variable insurance escalates an overall insurance earning rate. For example, in a year in which the earning rate of a variable insurance product is low, the variable insurance product is put into annuity finances, and other insurance products whose earning rates or interest rates are higher than the earning rate of the variable insurance product are left untouched and accumulated during the time period. On the other hand, in a year in which the earning rate of the variable insurance product is high, the variable insurance product is left untouched and accumulated, and the other insurance products whose earning rates are lower than the earning rate of the variable insurance product are put into annuity finances. Accordingly, it is possible to live on annuities until the annuity end with the maximum efficiency of insurance including other insurance products as well as the variable insurance product.

The escalating system 1 may satisfy everyone among a customer, an insurance company, and an insurance salesman and provides a new variable insurance sales technique for attracting a customer to variable insurance even when an earning rate of the variable insurance is 0%. When an insurance company or an insurance salesman sells variable insurance to a customer, the company or salesman exaggerates an earning rate of the variable insurance with an expected earning rate in some cases. This results in many civil petitions. With the escalating system 1 according to an exemplary embodiment, it is possible to induce a customer to imagine a synergy, which will be created when the volatility of earning rate of variable insurance and the sequential function are combined together, and purchase the variable insurance. In other words, it is unnecessary to tell a customer an expected earning rate, and a customer purchases variable insurance in consideration of a synergy that will be created when “the earning rate of variable insurance may increase or decrease” and the sequential function are combined together. Such a new variable insurance sales mechanism satisfies all of a customer, an insurance company, and an insurance salesman such that variable insurance can be sold in a totally different way than before. For this reason, the escalating system 1 can be referred to as a new variable insurance sales system that attracts people to variable insurance even when an earning rate of the variable insurance is 0%.

A configuration of the escalating system 1 with the above-described characteristic will be described in detail below.

Referring to FIG. 1, the escalating system 1 includes a collector 10, a controller 12, an output unit 14, and a storage 16. The escalating system 1 may be present in a computer and may operate through a program.

The collector 10 collects information required for escalating an overall insurance earning rate with variable insurance. As a collection method, the collector 10 may receive information directly from a policy holder, or may be connected to an insurance company server through network communication and receive the corresponding information from the insurance company. Otherwise, the collector 10 may load information previously stored in the storage 16.

The information collected by the collector 10 according to an exemplary embodiment includes insurance information of policy holders who want to receive an annuity through interim payments. Personal information of the policy holders may be included in the insurance information. The personal information is information for specifying the policy holders to inquire about information on insurance products that the policy holders have purchased. For example, the personal information may be social security numbers, insurance membership numbers, contract numbers, etc. but is not limited thereto. The insurance information may include insurance companies, names of the insurance products, types of the insurance products, monthly payments, annuity commencement ages, annuity end ages, interest rates, actual annuity receipts which will be used as interim payments, actual annuity finances, cancellation refund information, etc. but is not limited thereto. The policy holders may individually input their appropriate annuity commencement ages, annuity end ages, interest rates, actual annuity receipts which will be used as interim payments, actual annuity finances, and the like.

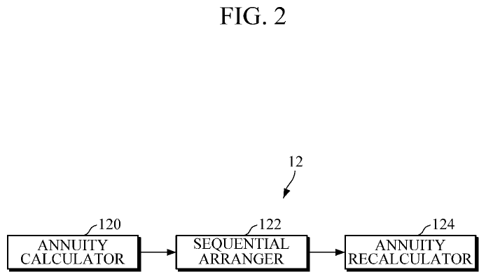

The controller 12 calculates annual earning rates of insurance products using the collected information and sequentially arranges annuities in a manner in which an insurance product with the lowest earning rate among the insurance products whose earning rates have been calculated is put into annuity finances every year starting from an annuity commencement until an annuity end and other insurance products are left untouched during the corresponding time period. Accordingly, it is possible to escalate an overall insurance earning rate with variable insurance. A detailed configuration of the controller 12 will be described in detail with reference to FIG. 2.

The output unit 14 outputs various kinds of information on a screen. The information includes information calculated by the controller 12, information for notifying a user of the detailed progress of a program, and the like. The storage 16 stores various kinds of information, which include, for example, information required for control of the controller 12, information generated due to control, and the like.

FIG. 2 is a block diagram showing a detailed configuration of a controller of FIG. 1 according to an exemplary embodiment of the present invention.

Referring to FIGS. 1 and 2, the controller 12 includes an annuity calculator 120, a sequential arranger 122, and an annuity recalculator 124.

The annuity calculator 120 calculates annual earning rates of each insurance product using the insurance information collected by the collector 10 and calculates possible annuity receipts based on the earning rates. When an insurance product is fixed-interest insurance, the annuity calculator according to an exemplary embodiment calculates an average of the lowest interest rate and a disclosed interest rate of the corresponding year as an annuity earning rate. When an insurance product is variable insurance, the annuity calculator 120 calculates an expected annuity commencement earning rate by averaging interest rates of a time period between a payment end and an annuity commencement of the policy holder and calculates expected annuity earning rates of years beginning with a second year after the annuity commencement according to whether an interim payment has been made in the corresponding year. For example, the annuity calculator 120 calculates an expected annuity commencement earning rate of variable insurance using an expression

$${\frac{am}{ap}}^{( \frac{1}{a 2 - a 1} )} - 1$$

and puts the calculated expected annuity commencement earning rate into a variable insurance earning rate of a first year after the annuity commencement. Here, ap is the total amount of payments, am is a cancellation refund of a year immediately before annuity commencement, a1 is a payment end age, and a2 is an annuity commencement age.

From the second year after the annuity commencement, the annuity calculator 120 according to an exemplary embodiment calculates an earning rate of a variable insurance product from which no interim payment has been made in the corresponding year using an expression (a/b)−1 and calculates an earning rate of a variable insurance product from which any interim payment has been made in the corresponding year using an expression ((a+p)/b)−1. Here, a is a cancellation refund reported by an insurance company at the end of the last year, b is a cancellation refund reported by the insurance company at the end of the year before last year, and p is the amount of interim payments.

When at least one of an earning rate, the amount of interim payments, and remaining annuity finances is changed, the annuity calculator 120 according to an exemplary embodiment recalculates new equal annuity receipts suitable for changed remaining finances every year. For example, when an interest rate is changed, the annuity calculator 120 recalculates annually-equal annuity receipts of years after a point of interest rate reset time in response to the changed interest rate. When the amount of interim payments are changed, the annuity calculator 120 recalculates annually-equal annuity receipts of years after a point of interim payment reset time in response to the changed amount of interim payments. When annuity finances are changed, the annuity calculator 120 recalculates annually-equal annuity receipts of years after a point of annuity finance reset time in response to the changed annuity finances. Accordingly, a policy holder may stably receive an equal annuity every year regardless of any change in interest rate (earning rate), stably receive an equal annuity every year even after a variable amount of interim payments, and stably receive an equal annuity even after any possible changes in finances.

The sequential arranger 122 sequentially arranges annuities in a manner in which an insurance product with the lowest earning rate among the insurance products whose earning rates have been calculated is put into annuity finances every year from the annuity commencement to the annuity end and other insurance products are left untouched during the corresponding time period. Here, the sequential arranger 122 puts a changeable insurance product with the lowest earning rate into annuity finances every year regardless of whether the insurance product is fixed-interest insurance or variable insurance, thereby improving overall insurance efficiency every year. While performing its variable function, variable insurance performs an overall insurance earning rate escalating function of increasing overall insurance efficiency every year until the annuity end by putting itself or another insurance product into annuity finances.

When there is an insurance product whose remainder is less than an annuity amount for one year during the sequential arrangement operation, the sequential arranger 122 according to an exemplary embodiment determines whether the insurance product is fixed-interest insurance or variable insurance. When the insurance product is fixed-interest insurance, the sequential arranger 122 adds the remainder to another insurance product. When the insurance product is variable insurance, the sequential arranger 122 sequentially arranges other insurance products and adds the remainder to another insurance product for settlement at the annuity end.

The annuity recalculator 124 recalculates additional annuity receipts so that a final remainder left behind in the sequential arrangement operation of the sequential arranger 122 may be additionally received as annuities. The annuity recalculator 124 according to an exemplary embodiment generates a comparative group whose annuity and remainder are a1 and x1 respectively, for comparison with an existing group whose final remainder and annuity are x, which is the final remainder left behind in the sequential arrangement operation, and a respectively, through sequential arrangement. Also, the annuity recalculator 124 separately calculates an annuity movement distance, a remainder movement distance, a remainder movement distance per annuity movement distance, an annuity movement distance by which the comparative-group annuity a1 additionally moves so that the comparative-group remainder x1 becomes 0, and a comparative-group annuity a2 for causing the comparative-group remainder x1 to be 0, and calculates annuity receipts that may be additionally received in a manner in which the comparative-group annuity a2 is input to a position of the comparative-group annuity a1 and circulates. Here, the annuity movement distance=the comparative-group annuity a1−the existing-group annuity a, the remainder movement distance=the comparative-group remainder x1−the existing-group remainder x, a remainder movement distance per annuity movement distance p=(x1−x)/(a1−a), an annuity movement distance q that the comparative-group annuity a1 additionally moves so that the comparative-group remainder x1 becomes 0=the comparative-group remainder x1/the remainder movement distance per annuity movement distance p, and a corrected annuity a1(a2), which may cause the comparative-group remainder x1 to be 0, equals a1+q.

Exemplary embodiments of the escalating system having the configuration described above with reference to FIGS. 1 and 2 will be described in detail below with reference to drawings.

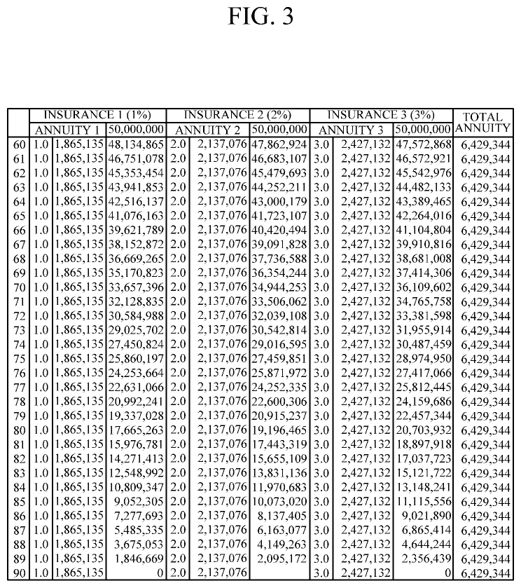

FIG. 3 shows an example of annuity receipts that a policy holder may receive in a general manner when the policy holder lives on annuities with a plurality of insurance products.

Referring to FIG. 3, an annuity receipt table shows ages of a policy holder, interest rates (earning rates), yearly possible annuity receipts, and remaining annuity finances depending on insurance products. As shown in FIG. 3, assuming that a policy holder converts insurance 1 (interest rate: 1%), insurance 2 (interest rate: 2%), and insurance 3 (interest rate: 3%) with 50,000,000 won each into annuities and then starts living on the annuities, in a general method, the policy holder receives 1,865,135 won (insurance 1)+2,137,076 won (insurance 2)+2,427,132 (insurance 3)=a total of 6,429,344 won every year from the age of 60 to the age of 90.

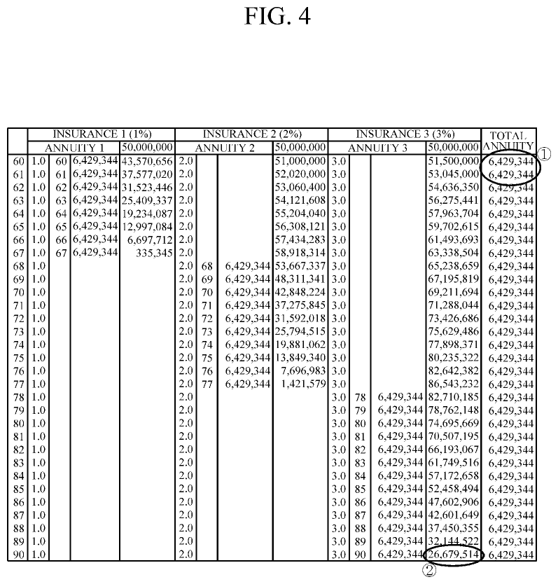

FIG. 4 shows an example of annuity receipts that may be received in a sequential annuity calculation method according to an exemplary embodiment of the present invention.

Referring to FIG. 4, it is possible to receive an annuity by sequentially arranging annuity insurance products according to an exemplary embodiment. For example, FIG. 4 shows annuity receipts that may be annually received when annuities are sequentially started in order of insurance 1 (interest rate: 1%), insurance 2 (interest rate: 2%), and insurance 3 (interest rate: 3%). In this case, even after 6,429,344 won is annually received \textcircled{1} like in the case of FIG. 3, 26,679,514 won is unused in the end \textcircled{2}. Then, instead of leaving the annuity, it is possible to additionally receive a certain amount of annuity.

Furthermore, the present invention proposes a sequential annuity calculation method when variable insurance is included in insurance products. When all insurance products of a policy holder are disclosed-interest insurance, such as insurance 1 (interest rate: 1%), insurance 2 (interest rate: 2%), and insurance 3 (interest rate: 3%), a sequential arrangement order of the insurance products is determined as shown in FIG. 4 upon annuity commencement at the age of 60. However, when variable insurance is included in the insurance products, it is not possible to sequentially arrange all the insurance products. Since variable insurance has a variable earning rate, it is not possible to determine a position of the variable insurance, and for this reason, it is not possible to sequentially arrange all the insurance products.

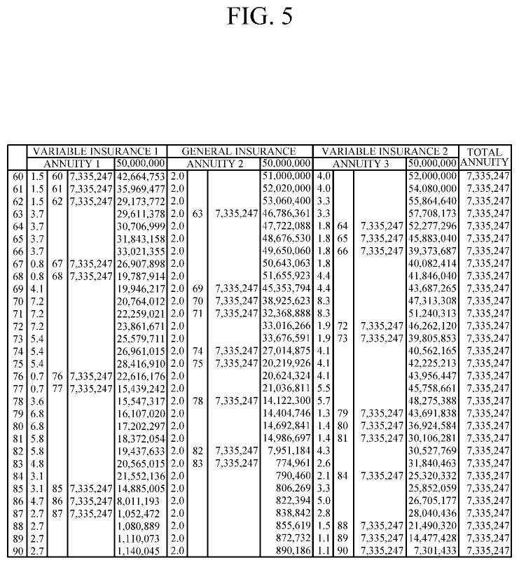

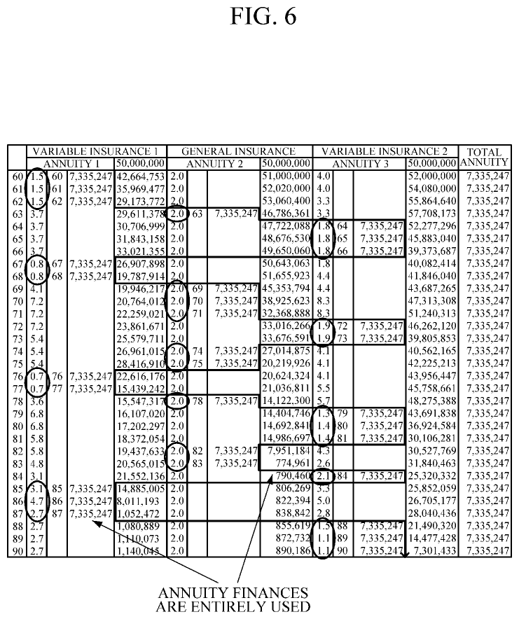

FIGS. 5 and 6 are program screens showing that when a policy holder lives on annuities with a plurality of insurance products, including at least one variable insurance product, it is possible to receive optimal annuities through an annuity calculation program according to an exemplary embodiment of the present invention.

As shown in FIG. 5, it is assumed that only annuity 2 is general insurance and both annuity 1 and annuity 3 are variable insurance. In fact, it does not matter how many variable insurance products are included. As long as there is at least one variable insurance among insurance products of a policy holder, the same principle is applied. The principle corresponds to a manner in which a changeable insurance product with the lowest earning rate is put into annuity finances every year regardless of whether the insurance product is fixed-interest insurance or variable insurance.

For example, when the policy holder has a total of 3 insurance products, that is, variable insurance 1, variable insurance 2, and general (disclosed interest) insurance, as shown in FIG. 6, at his or her ages of 60, 61, and 62, variable insurance 1 has the lowest earning rate (interest rate) of 1.5% and thus is put into annuity finances, and other insurance products having higher earning rates than variable insurance 1 during the corresponding time period are left untouched such that principals and interests are accumulated at the corresponding interest rates during the corresponding years and the remainder of annuity finances increases. At the age of 63, the earning rate of variable insurance 1 increases to 3.7%. Therefore, general insurance having an earning rate of 2% lower than that of variable insurance 1 is put into annuity finances, and variable insurance 1 and variable insurance 2 whose earning rate is 3.3% are left untouched such that the remainder of annuity finances increases. At the ages of 64, 65, and 66, variable insurance 1 still has a high earning rate, but variable insurance 2 has a reduced earning rate of 1.8%, which is the lowest among earning rates of the insurance products. Therefore, variable insurance 2 is put into annuity finances, and other insurance products are left untouched such that the remainder of annuity finances increases. In this way, a changeable insurance product with the lowest earning rate among all the insurance products is put into annuity finances every year until an annuity end, and other insurance products are left untouched and accumulated during the corresponding time period. Therefore, it is possible to live on the annuities with the maximum annuity efficiency every year until the end.

When there is no variable insurance, it is not possible to imagine or achieve such an effect, which is an unexpected positive effect resulting from interactions between the sequential technique and the volatility of earning rate which is the existing characteristic of variable insurance. In other words, purchasing variable insurance copies the traditional paradigm “high risk-high returns,” but the volatility of earning rate of variable insurance which originally exists as risk combines with the sequential function such that the risk operates as an opportunity instead.

As the sequential function is combined with variable insurance, the variable insurance is first put into annuity finances in some years and is later put into annuity finances in some other years such that a synergy which is unimaginable until variable insurance combines with the sequential function may be created between the variable function and the sequential function. Here, a variable insurance product of a policy holder has a positive influence on insurance products of the policy holder including the variable insurance product. Therefore, it is possible to achieve an effect of the maximum efficiency every year. Since the variable function combines with the sequential function and increases overall insurance efficiency until immediately before annuities end, it is possible to expect an overall insurance earning rate escalating effect with variable insurance.

Until now, when insurance companies, security companies, etc. sell variable insurance, they have no choice but to concentrate on how the earning rate of variable insurance can be increased and post irrational expected earning rates or create irrational theories sometimes. Therefore, when the earning rates of variable insurance do not reach expected values after a certain time period, conflicts with policy holders may occur. However, by using the technique of escalating an overall insurance earning rate with variable insurance according to an exemplary embodiment, there is no need to notify the earning rate of variable insurance to a customer and it is just necessary to notify a customer of the synergy which may be created when the variable function of variable insurance combines with the sequential function. Unlike the insurance sales principle which mainly targets a high earning rate hitherto posted by insurance companies or financial companies, it is possible to bring a motivation for purchasing variable insurance to a customer which is totally different from the existing motivation. In other words, a new variable insurance sales mechanism is provided in which a customer is attracted to variable insurance even when the earning rate of the variable insurance is 0%.

A mechanism of purchasing variable insurance becomes totally different from the existing mechanism of inducing a customer to purchase variable insurance with the earning rate thereof. This new variable insurance sales mechanism may solve the problems that occur when variable insurance is packaged with a high earning rate and sold according to the existing variable insurance sales method. In other words, insurance companies do not need to exaggerate the earning rate of variable insurance any more to increase sales, and insurance salesmen do not need to irrationally sell variable insurance such that incomplete sales of variable insurance may be considerably reduced. Accordingly, insurance sales are possible on the basis of the new sales mechanism that satisfies everyone among a customer, an insurance company, and an insurance salesman.

The technique of escalating an overall earning rate with variable insurance according to an exemplary embodiment involves an insurance salesman not telling the earning rate of a variable insurance product when selling the variable insurance product but explaining that the variable function of variable insurance, which simply indicates that the earning rate may increase or decrease, and the sequential function are combined together to put the variable insurance product into annuity finances in a year in which the earning rate of the variable insurance product is low and to leave untouched and accumulate the variable insurance product and put other insurance products into annuity finances instead in a year in which the earning rate of the variable insurance product is high, such that the volatility of earning rate of variable insurance combines with the sequential function every year to increase overall insurance efficiency until the end, that is, to allow living on annuities with the maximum efficiency until the end. This is because a customer purchases variable insurance not due to a high expected earning rate of variable insurance but due to the synergy between the variable function and the sequential function.

When customers are notified of this effect, customers who have one or two general annuity insurance products may want to purchase variable insurance even without encountering a promotion with an expected earning rate of variable insurance. Also, when a customer having, for example, three annuity insurance products with disclosed interest rates does not have money to spare for an additional insurance product, the customer may want to change at least one of the three insurance products to a variable insurance product. When a customer has one insurance product with one million won per month, the customer may want to divide the money, put 500,000 won into general annuity insurance, and put 500,000 won into variable insurance.

In Korea, about half of policy holders have variable insurance. In this situation, an annuity commencement era is coming for policy holders who have purchased variable insurance at the early stage. Therefore, it is urgent to propagate this principle. The escalating system according to an exemplary embodiment will systematically show how the variable function of variable insurance combines with the sequential technique to create the synergy.

The escalating system according to an exemplary embodiment will be described below. First, the escalating system provides an annuity calculation program that tells in real time how much annuity a policy holder may additionally receive when the policy holder sequentially receives annuities in comparison with the general simultaneous annuity conversion method. Second, the escalating system escalates an overall insurance earning rate. Third, the escalating system causes key elements, such as annual sequential changes in position, to interoperate with each other.

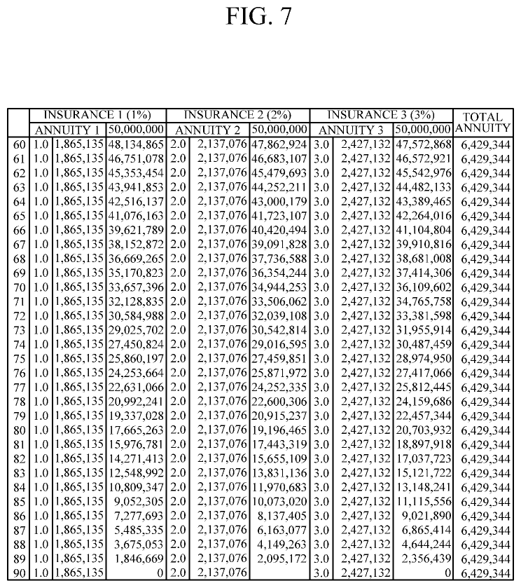

FIGS. 7 to 19 illustrate an annuity calculation program that tells how much annuity may be additionally obtained from a remainder with a sequential annuity arrangement according to an exemplary embodiment of the present invention in comparison with the general simultaneous annuity conversion method.

FIG. 7 shows possible annual annuity receipts of a policy holder when the policy holder receives annuities in the general method through insurance-to-annuity conversion for living on the annuities.

Referring to FIG. 7, when the three insurance products of the policy holder are simultaneously converted into annuities in the general method, the policy holder receives 1,865,135 won+2,137,076 won+2,427,132=6,429,344 won every year, and the annuities end with 0 won.

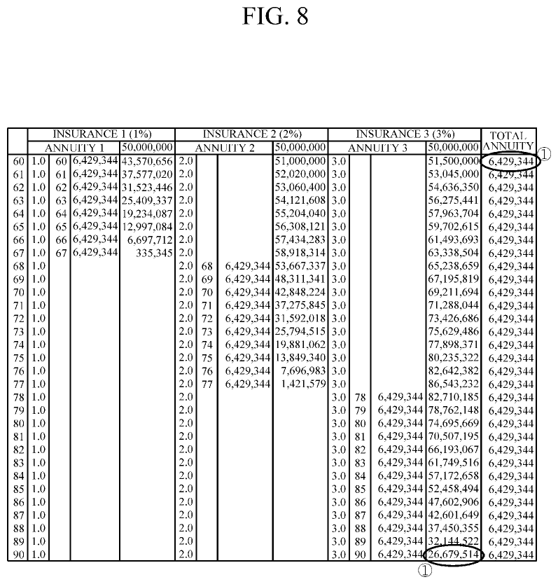

FIG. 8 shows possible annual annuity receipts of a policy holder when the policy holder converts insurance products into annuities for living on the annuities and receives annuities in the sequential method.

As shown in FIG. 8, when the annuities are received in order of insurance 1, insurance 2, and insurance 3, 26,679,514 won is unused in the end even after 6,429,344 won is received annually \textcircled{1}. Then, it is possible to additionally receive annuities. What amount of annuity may be additionally received?

In the case of FIG. 8, when an annuity of 6,429,344 won is received every year, 26,679,514 won is unused in the end. Therefore, the policy holder may want to additionally receive annuities without leaving any remainder, but it is difficult to know how much additional annuity is required to leave no remainder at the end. Even when it is simply attempted to set the remainder to 0 and calculate additional annuity receipts by adding possible annuity receipts upward, it is necessary to know possible annuity receipts but also impossible. In addition, when there is only one interest rate, it is possible to add possible annuity receipts upward, but there are different interest rates. Further, it is necessary to perform the addition upward in a stair shape. In this situation where different elements are mixed, it is not easy to perform the calculation.

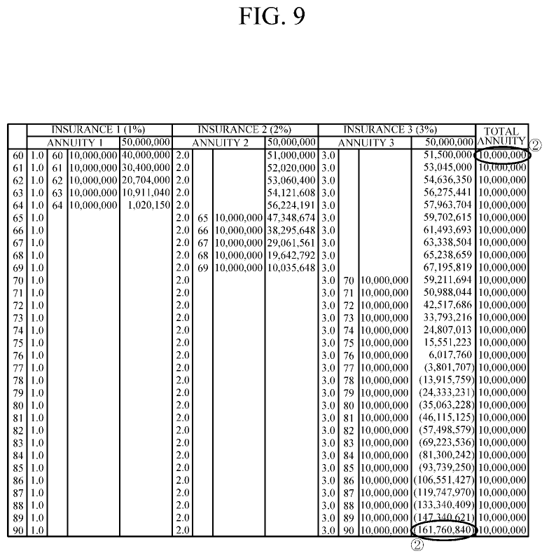

The present invention proposes a program for calculating additional annuity receipts. First, the existing case of FIG. 8 in which the annuity of 6,429,344 won is received and the remainder of 26,679,514 won is unused is considered as an existing start (an existing group), and one arbitrary comparative group in which an annuity of 10,000,000 won is received every year and a certain amount of remainder is left is additionally generated as shown in FIG. 9.

FIG. 9 shows a first comparative group according to an exemplary embodiment of the present invention.

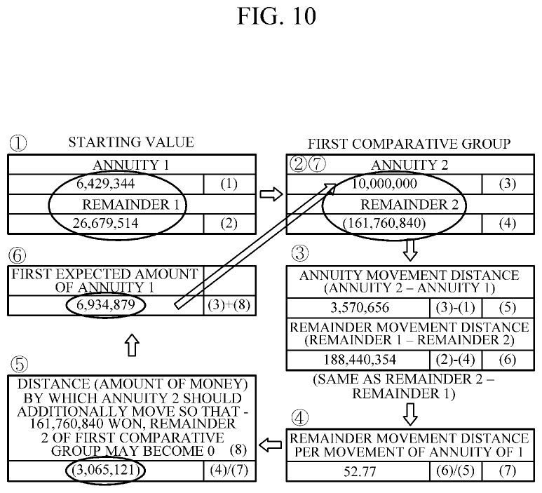

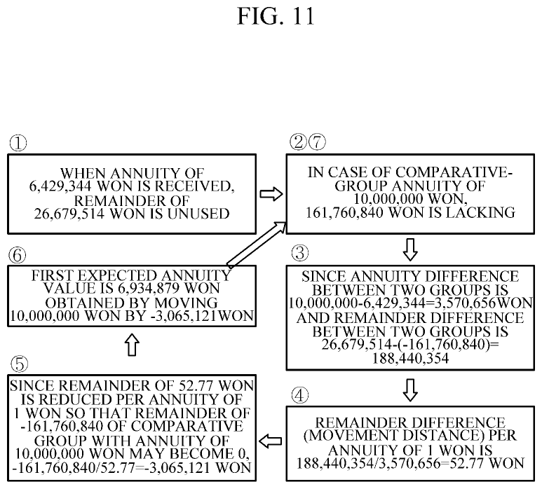

Referring to FIG. 9, in the first comparative group, a remainder of −161,760,840 won is unused in the end when the annuity of 10,000,000 won is input to the position of annuity finances \textcircled{2} and annuities are received in order of insurance 1, insurance 2, and insurance 3. Here, the existing start group (FIG. 8) \textcircled{1} and the comparative group (FIG. 9) \textcircled{2} are compared such that “annuity movement distances” and “remainder movement distances” are compared between \textcircled{1} and \textcircled{2}. As a result, chain equations are generated as shown in FIGS. 10 and 11.

In other words, in FIGS. 8 and 9,

(1) Annuity movement distance (annuity interval)=10,000,000−6,429,344=3,570,656

(2) Remainder movement distance (remainder interval)=26,679,514−(−161,760,840)=188,440,354 (since the purpose is to find the distance, a distance value obtained by subtracting the latter from the former is the same as a distance value obtained by subtracting the former from the latter regardless of their signs)

(3) Remainder movement distance per annuity movement distance=(2)/(1)=188,440,354/3,570,656=52,7747

(4) Annuity movement distance required for comparative-group remainder−161,760,840 to be 0=−161,760,840/52.7747=−3,065,121, and

(5) The comparative-group remainder of −161,760,840 corresponds to the case in which the comparative-group annuity is 10,000,000.

Therefore, an annuity value which will be primarily calculated (which will result in a remainder of 0)=10,000,000+(−3,065,121)=6,934,879=a value \textcircled{6} of FIG. 10.

Subsequently, the calculated first value of 6,934,879 is input to the position of 10,000,000 at the upper right side of FIG. 9 and continuously circulates.

Referring to FIGS. 10 and 11, the first value of 6,934,879, which is calculated at \textcircled{6} by circulating 10,000,000 won clockwise one round from \textcircled{2}, is newly input to \textcircled{7} and continuously circulates.

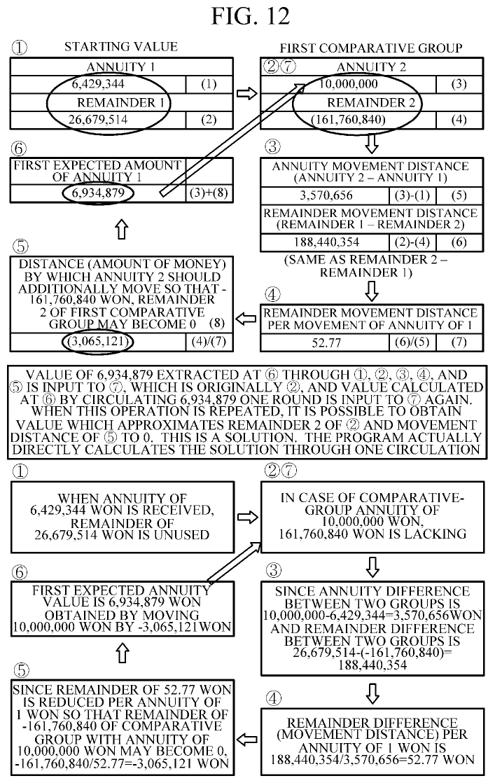

FIG. 12 is a diagram illustrating the continuous circulation example of FIGS. 10 and 11 according to an exemplary embodiment of the present invention.

Referring to FIG. 12, the first annuity value of 6,934,879 extracted at \textcircled{6} through \textcircled{1}, \textcircled{2}, \textcircled{3}, \textcircled{4}, and \textcircled{5} is input to \textcircled{7}, which is originally \textcircled{2}, and a value calculated at \textcircled{6} by circulating the first annuity value of 6,934,879 one round is input to \textcircled{7} again. When this operation is repeated, it is possible to obtain a value which approximates remainder 2 of \textcircled{2} and a movement distance of \textcircled{5} to 0. This is the solution. Actually, the program directly calculates the solution through one circulation.

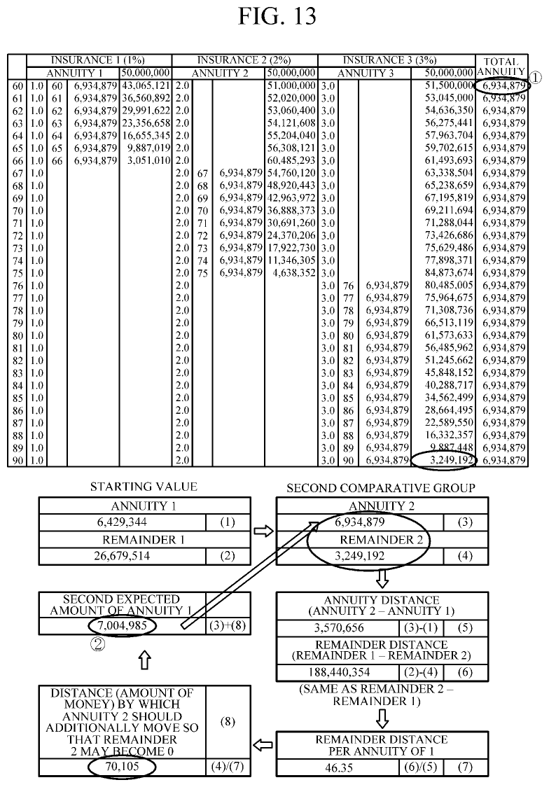

FIG. 13 is a diagram showing a second comparative group according to an exemplary embodiment of the present invention.

Referring to FIG. 13, when the first expected annuity value of 6,934,879 extracted at \textcircled{6} of FIG. 10 is input to \textcircled{1}, a second expected annuity \textcircled{2} of 7,004,985 is calculated and circulates one round.

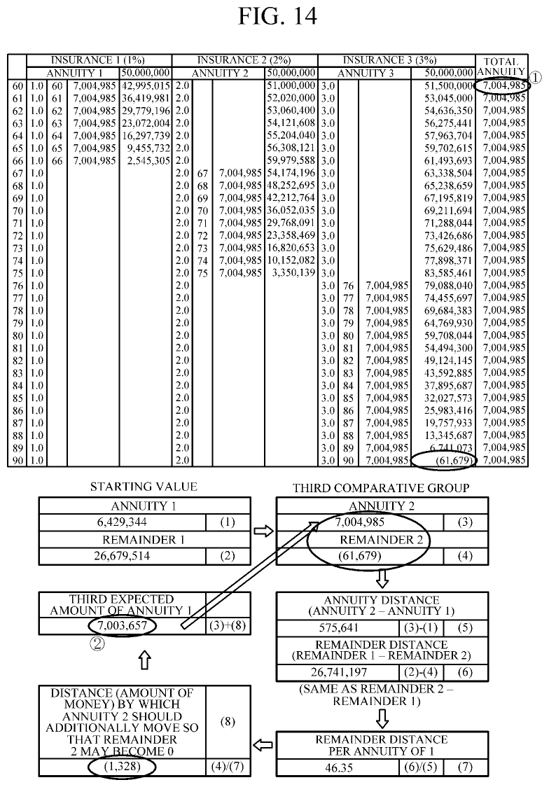

FIG. 14 is a diagram showing a third comparative group according to an exemplary embodiment of the present invention.

Referring to FIG. 14, when the second expected annuity value of 7,004,985 extracted at \textcircled{2} of FIG. 13 is input to \textcircled{1}, a third expected annuity \textcircled{2} of 7,003,657 is calculated and circulates one round.

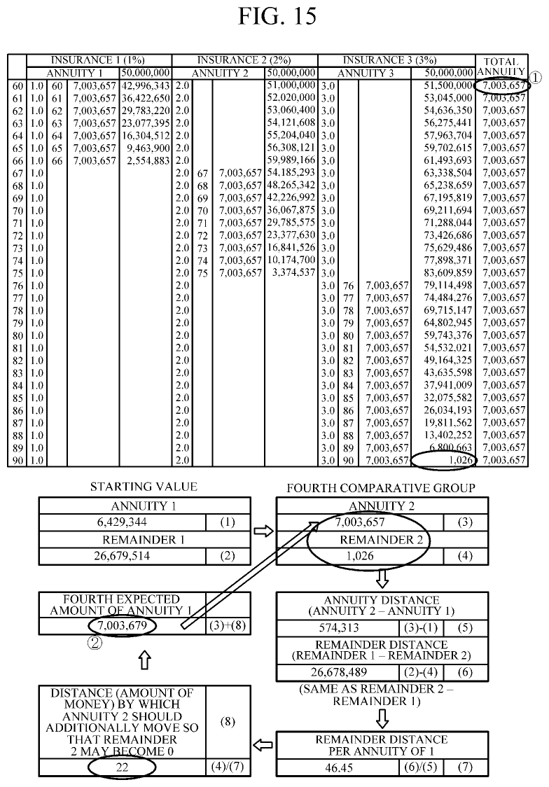

FIG. 15 is a diagram showing a fourth comparative group according to an exemplary embodiment of the present invention.

Referring to FIG. 15, when the third expected annuity value of 7,003,657 extracted at \textcircled{2} of FIG. 14 is input to \textcircled{1}, a fourth expected annuity \textcircled{2} of 7,003,679 is calculated and circulates one round.

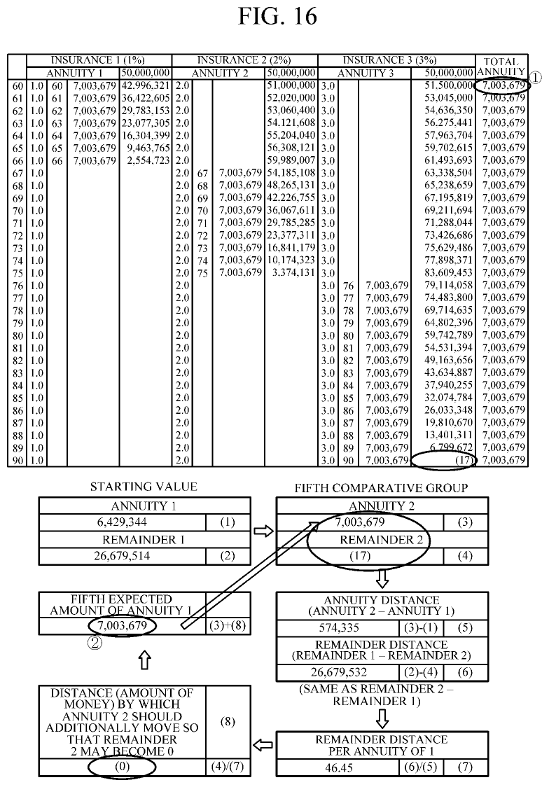

FIG. 16 is a diagram showing a fifth comparative group according to an exemplary embodiment of the present invention.

Referring to FIG. 16, when the fourth expected annuity value of 7,003,657 extracted at \textcircled{2} of FIG. 15 is input to \textcircled{1}, a fifth expected annuity \textcircled{2} of 7,003,679 is calculated and circulates one round.

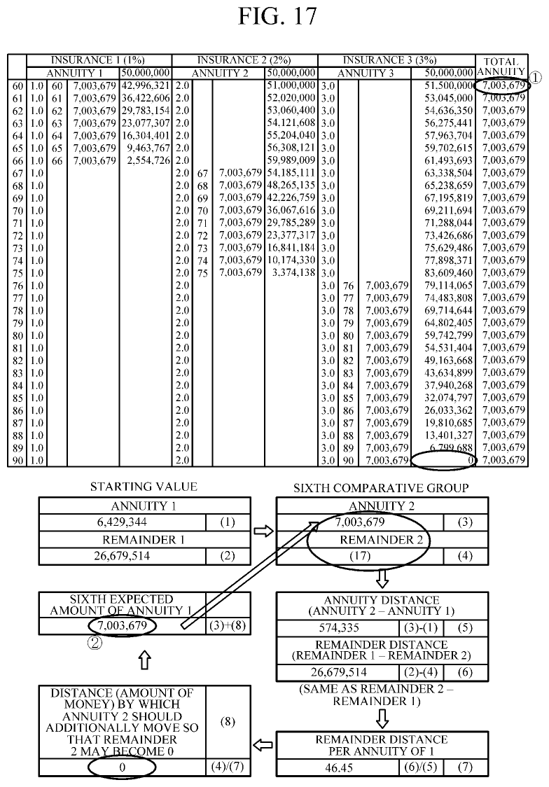

FIG. 17 is a diagram showing a sixth comparative group according to an exemplary embodiment of the present invention.

Referring to FIG. 17, when the fifth expected annuity value of 7,003,679 extracted at \textcircled{2} of FIG. 16 is input to \textcircled{1}, a sixth expected annuity \textcircled{2} of 7,003,679 is calculated and circulates one round.

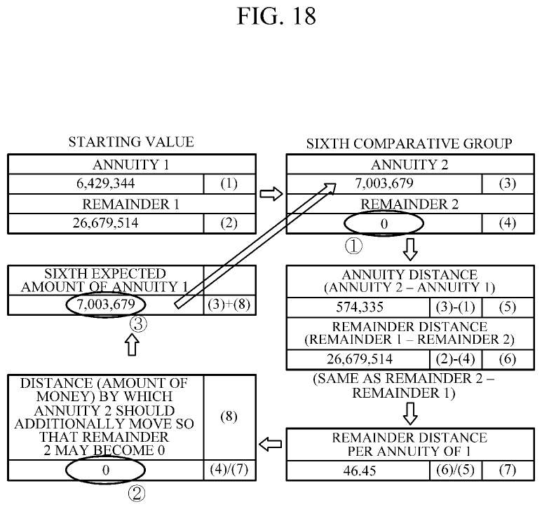

FIG. 18 is a diagram showing that a remainder becomes 0 through automatic circulation according to an exemplary embodiment of the present invention.

Referring to FIG. 18, \textcircled{1} and \textcircled{2} are gradually reduced to 0 in the end. This denotes that \textcircled{3} is the final solution, and this calculation program is run ten more times thereafter. Then, the final value \textcircled{3} is linked to an initial position whose value is sought for.

This process is configured to be automatically performed again until the remainder becomes 0 through the program. Therefore, when a policy holder inputs an initial value to an item that the policy holder seeks for, a final solution is automatically calculated.

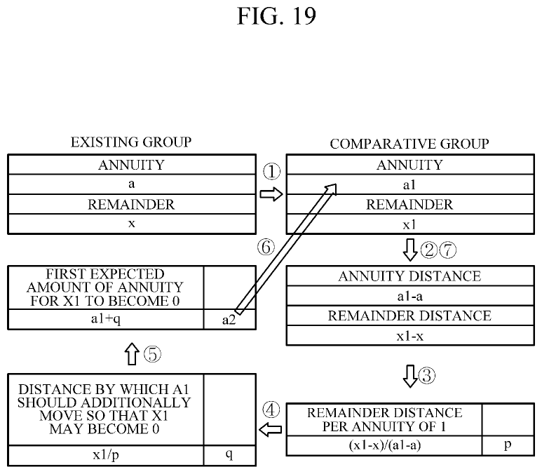

FIG. 19 illustrates an equation for automatically calculating how much additional annuity may be received from a remainder left behind sequential insurance arrangement, which has been described with reference to FIGS. 7 to 18.

Assuming that a remainder is x when an annuity is a in the existing group and a remainder is x1 when an annuity is a1 in a comparative group,

(1) Annuity movement distance (annuity interval)=comparative-group annuity a1−existing-group annuity a

(2) Remainder movement distance (remainder interval)=comparative-group remainder x1−existing-group remainder x

(3) Remainder movement distance per annuity movement distance p=(2)/(1)=(x1−x)/(a1−a)

(4) Annuity movement distance q that the comparative-group remainder a1 moves so that the comparative-group remainder x1 may become 0=x1/p

(5) Primarily corrected value a2 of the annuity a1 for causing the comparative-group remainder x1 to be 0=a1+q, and

(6) a2 is input to the position of a1 and circulates.

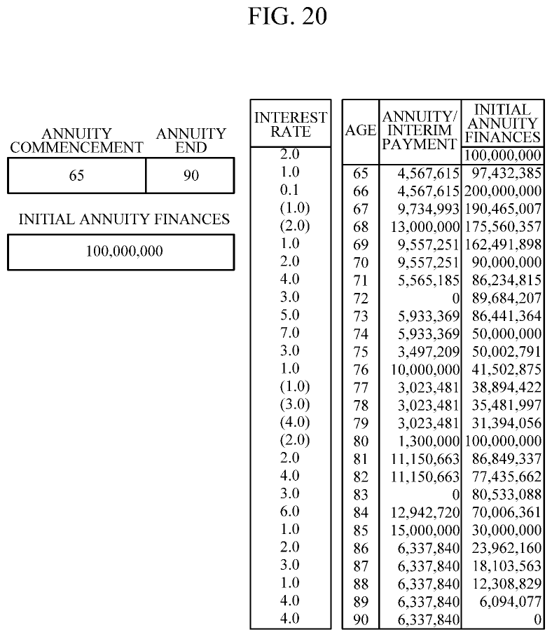

FIG. 20 shows an all-around annuity calculation program for calculating new stable equal annuity amounts (the amount of interim payments) in response to an environmental change according to an exemplary embodiment of the present invention.

Referring to FIG. 20, the all-around annuity calculation program according to an exemplary embodiment of the present invention immediately reacts to a change of all elements of an annuity not only including an annuity commencement age and an annuity end age but also including a change in interest rate (earning rate), a change in annuity receipts (interim payments), and a change in remainder and calculates new stable equal annuity amounts (the amount of interim payments). The annuity calculation program is a program that reacts to a change of all elements of an annuity and causes a remainder to be 0 as shown in FIG. 20.

The all-around annuity calculation program for variable insurance calculates an expected interest rate using an expression

$${\frac{am}{ap}}^{( \frac{1}{a 2 - a 1} )} - 1.$$

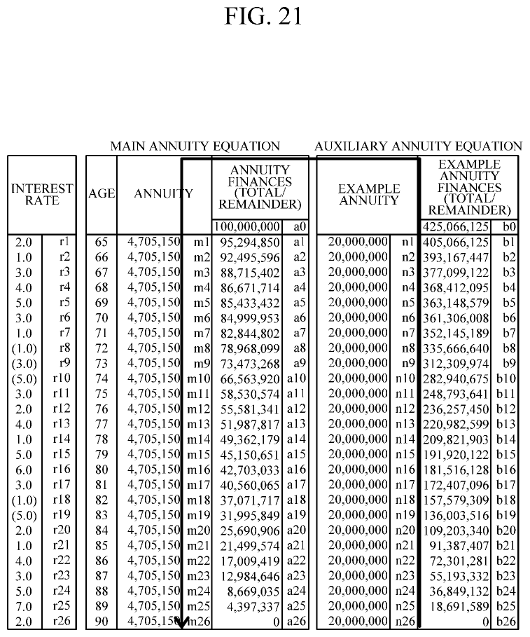

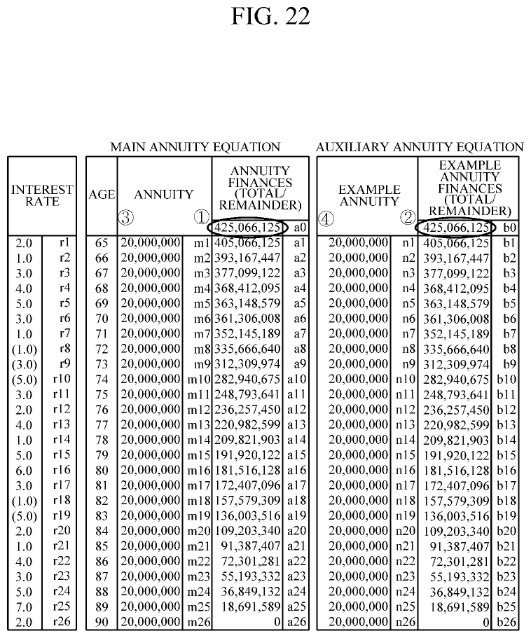

Here, ap is the total amount of payments, am is a cancellation refund of a year immediately before annuity commencement, a1 is a payment end age, and a2 is an annuity commencement age. In consideration of the expected interest rate, equal annuity receipts are calculated for years after annuity commencement. In this case, new stable equal annuity amounts (the amount of interim payments) may be calculated in immediate response to a change of all elements of an annuity including a change in interest rate (earning rate), a change in annuity receipts (interim payments), a change in remainder, and the like. For example, the annuity calculation program may immediately react to a change of all elements by creating a main annuity table and an auxiliary annuity table and connecting a main annuity equation and an auxiliary annuity equation. The main annuity table shows remainders after interim payments calculated downward by subtracting an annuity amount every year from an annuity commencement year to an annuity end year. The auxiliary annuity table shows a final total amount of money calculated by adding annual certain example annuities upward from the annuity end year to the annuity commencement year. An exemplary embodiment corresponding thereto will be described below with reference to FIGS. 21 and 22.

FIG. 21 shows a calculation method of an annuity calculation program according to an exemplary embodiment of the present invention.

Referring to FIG. 21, the annuity calculation program includes a main annuity equation program (on the left side of FIG. 21) and an auxiliary annuity equation program (on the right side of FIG. 21).

1. Auxiliary Annuity Equation

The auxiliary annuity equation program calculates a final total amount of money by adding annual payments upward from the bottom end. To this end, the following equations are constructed upward from the bottom end.

Assuming that annual annuities of n1=n2=n3= . . . =n26 are 20,000,000 (this is an example, and other amounts of money are also acceptable), b25 to b1 are calculated through the auxiliary annuity equation program as follows.

$$b 25 = ( b 26 + n 26 ) \text{/} ( 1 + r 25 ) \text{:} 18 , 691 , 589 = ( 0 + 20 , 000 , 000 ) \text{/} ( 1 + 7 \% ) \\ b 24 = ( b 25 + n 25 ) \text{/} ( 1 + r 24 ) \text{:} 36 , 849 , 132 = ( 18 , 691 , 589 + 20 , 000 , 000 ) \text{/} ( 1 + 5 \% ) \\ … \\ … \\ … \\ b 1 = ( b 2 + n 2 ) \text{/} ( 1 + r 1 ) \text{:} 405 , 066 , 125 = ( 393 , 167 , 447 + 20 , 000 , 000 ) \text{/} ( 1 + 2 \% ) \\ b 0 = b 1 + n 1 \text{:} 425 , 066 , 125 = 40 \; 5 , 066 , 125 + 20 , 000 , 000 \qquad ( 1 )$$

2. Main Annuity Equation

Since the main annuity equation program subtracts money from actually provided annuity finances downward from the upper end (at the same interest rates as adding annual payments upward) to leave 0 at the end, calculations are performed by constructing equations downward from the upper end.

Since the initially provided annuity finances are 100,000,000, a1 to a26 from the upper end are as follows.

$$a 1 = a 0 - m 1 \text{:} 95 , 294 , 850 = 100 , 000 , 000 - 4 , 705 , 150 \\ a 2 = a 1 \times ( 1 + r 1 ) - m 2 \text{:} 92 , 495 , 596 = 95 , 294 , 850 \times ( 1 + 2 \% ) - 4 , 705 , 150 \\ a 3 = a 2 \times ( 1 + r 2 ) - m 3 \text{:} 88 , 715 , 402 = 92 , 495 , 596 \times ( 1 + 1 \% ) - 4 , 705 , 150 \\ … \\ … \\ … \\ a 26 = a 25 + ( 1 + r 25 ) - m 26 \text{:} 0 = 4 , 397 , 337 \times ( 1 + 7 \% ) - 4 , 705 , 150 \qquad ( 2 )$$

In the case of (2), a1=a0−m1 without any calculation with an interest rate unlike the subsequent equations for the following reason.

Since an annuity commencement year corresponds to the age of 65, annuity finances provided at the last day of the age of 64 (=the first day of the age of 65) are a0. a1 is a remainder left after subtracting an annual annuity m1 from the total annuity finances a0 at the annuity commencement day corresponding to the age of 65. m1 and a1 separately recorded in different accounts. While m1 is spent for one year, an interest corresponding to an interest rate r1 of the corresponding time period is added to a1 such that a1 increases. After that, a series of a is continuously increased by an interest rate for one year, and a series of m is subtracted from the series of a every year. In this way, the annuity proceeds until the end. In other worlds, the amount of money obtained by subtracting a second-year annuity m2 from the principal and interest of a1 corresponding to one year is a2.

<a1×(1+r1)−m2=a2>

Again, the amount of money obtained by subtracting a third-year annuity m3 from the principal and interest, which corresponds to a2 increased for one year, is a3.

<a2×(1+r2)−m3=a3>

. . .

This is repeated until the annuity end.

In other words, a0 and a1 have different values but correspond to the same day. a0 is the sum of m1 and a1 because there is no time to be increased by an interest rate. After that, a1, a2, and a3 are continuously increased by interest rates for one year each, and a series of m is subtracted from the amounts of money increased by the interest rates. This is repeated until the end.

This is also applied to (1) of the auxiliary annuity equation on the right side of FIG. 21 such that the upper end of the auxiliary annuity equation becomes “b0=b1+n1 (425,066,125=405,066,125+20,000,000).”

Equations used upward are used downward in the same way.

3. Connection Between Main Annuity Equation and Auxiliary Annuity Equation

The example annuities n1 to n26 of the auxiliary annuity equation satisfy n26=n25=n24= . . . =n2=n1 upward from the bottom end. Therefore, m1 to m26 of the main annuity equation also satisfy m1=m2=m3= . . . =m25=m26 downward from the upper end. However, unlike n1 to n26 of the auxiliary annuity equation, m1 to m26 of the main annuity equation are annual expected amounts of interim payments, which may vary every year. Therefore, when the equations are constructed, it is necessary to break the equal relationship m1=m2=m3= . . . =m25=m26 downward from the upper end. To break the up-down relationship and connect the left and right sides, the relationship m1=m2=m3 is destroyed, and left-right connection equations are established instead as follows.

m1=(a0/b0)×n1

m2=(a1/b1)×n2

m3=(a2/b2)×n3

Then, m1 to m26 are calculated downward. In this way, all of m1 to m26 may have different values.

FIG. 22 shows an example of verification of the annuity calculation program of FIG. 21 according to an exemplary embodiment of the present invention.

Referring to FIG. 22, when 425,066,125 won, which is the amount of money input to \textcircled{2}, is input \textcircled{1} where 100,000,000 won has been originally present in FIG. 21, and \textcircled{3} is input to the above equation “m1=(a0/b0)×n1,” it is possible to see that the equation holds as “20,000,000=(425,066,125/425,066,125)×20,000,000.”

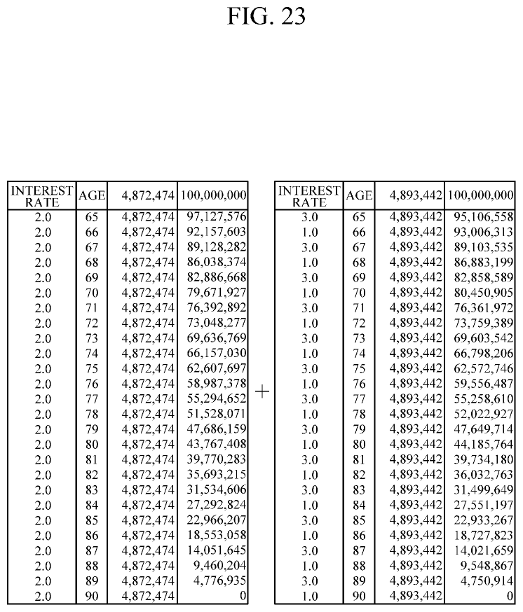

FIG. 23 shows a policy holder's two insurance products that are joined together to illustrate the principle of escalating an overall insurance earning rate with variable insurance according to an exemplary embodiment of the present invention.

Specifically, the left side of FIG. 23 shows a general insurance product with a fixed interest rate of 2%, and the right side shows a variable insurance product with an expected earning rate which is set to a higher interest rate (3%) or a lower interest rate (1%) than the left side.

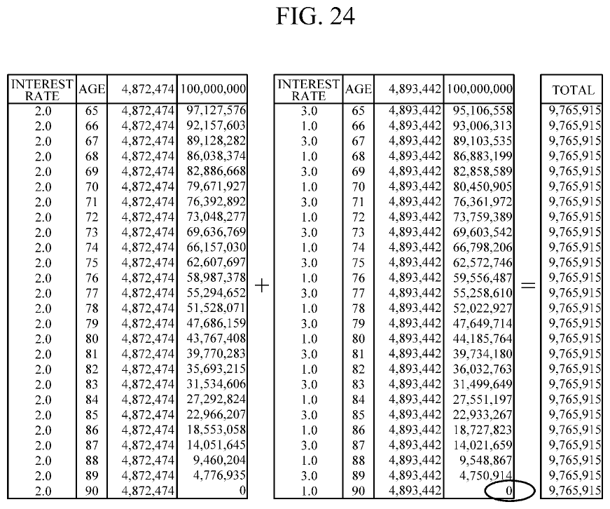

FIG. 24 shows possible annuity receipts when annuities are received in the general method in the exemplary embodiment of FIG. 23.

Referring to FIGS. 23 and 24, in the general method, it is possible to receive an annuity of 4,872, 474 won from the left insurance product and receive an annuity of 4,893,442 won from the right insurance product, that is, a total of 9,765, 915 won.

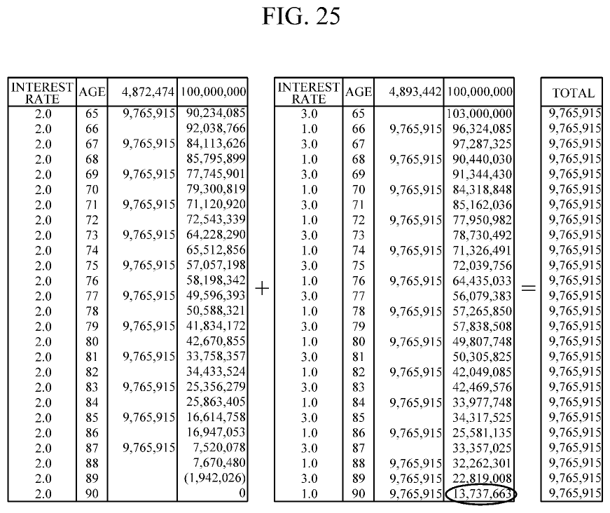

FIG. 25 shows possible annuity receipts when annuities are received in the sequential method in the exemplary embodiment of FIG. 23.

Referring to FIG. 25, the left and right insurance products of FIG. 23 are compared with each other. An insurance product with a lower interest rate is caused to cover a whole annuity of 9,765,915 won, and the other insurance product with a higher interest rate is left untouched during the corresponding time period so that remaining annuity finances may be increased. Then, 13,737,663 won is unused even after 9,765,915 won, which is the example of FIGS. 23 and 24, is annually received until the annuities end.

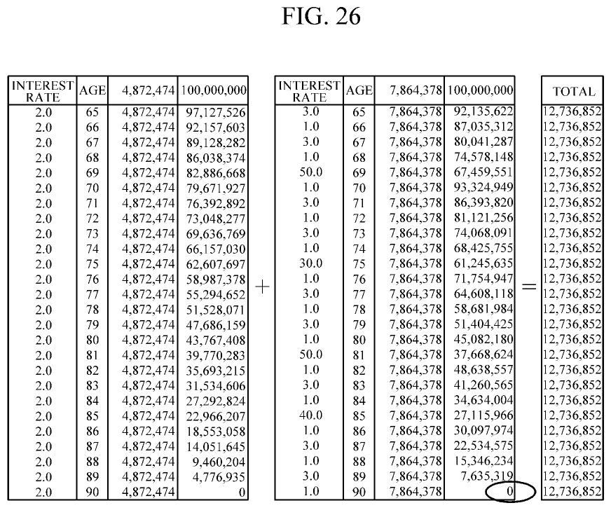

FIG. 26 shows possible annuity receipts when annuities are received in the general method when a high profit is made from variable insurance.

Referring to FIG. 26, it is assumed that a policy holder has two insurance products, and high profits of 50%, 30%, and 40% may be made from one of the insurance products (the right side of FIG. 26) a few times during the overall variable annuitant living of tens of years. When the annuities are received in the general method, annuity receipts that may be received from the left and right insurance products are 4,872,474+7,864,378=12,736,852 won.

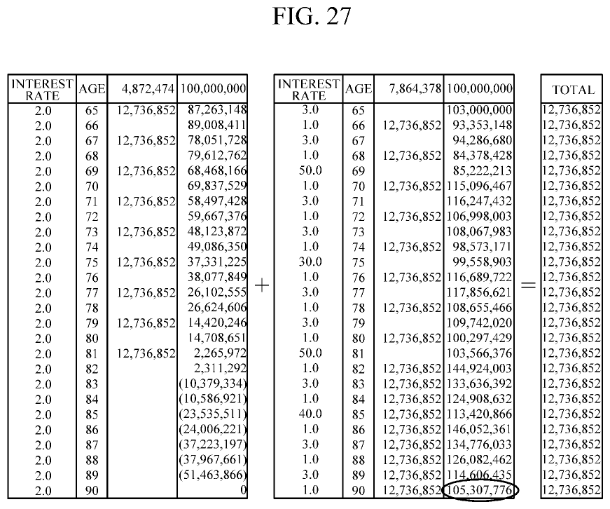

FIG. 27 shows a remainder when annuities are received in the sequential method in the example of FIG. 26 according to an exemplary embodiment of the present invention.

Referring to FIG. 27, when 12,736,862 won is annually received from an insurance product with the lower earning rate, 105,305,776 won is unused even after 12,736,852 won, which is the same as the example of FIG. 26, is annually received. As shown in FIG. 27, the left and right insurance products alternately cover the annual cost of living until the age of 81. However, from the age of 82, the left insurance product lacks for annuity finances, and thus the right insurance product solely covers the remaining annuitant living. At the end, a remainder of 105,307,776 won is unused.

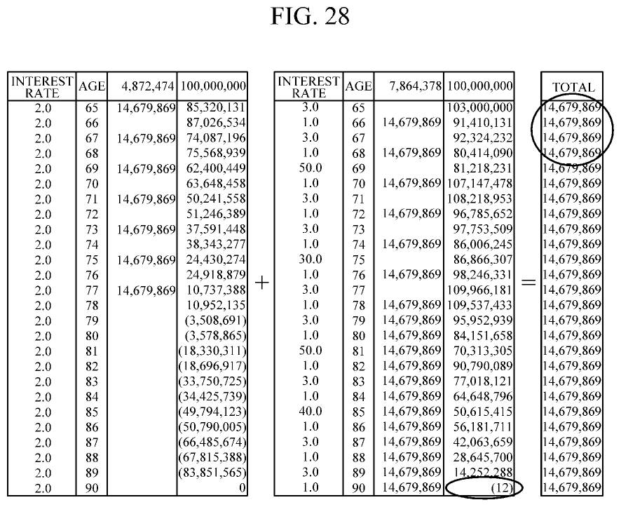

FIG. 28 shows a case of increasing annuity receipts in the situation of FIG. 27.

Referring to FIG. 28, when annuity receipts (the amount of interim payments) are increased from 12,736,852 won to 14,679,869 won in the example of FIG. 27, it is possible to additionally receive an annuity of about 2,000,000 (15.3%) every year.

14,679,869−12,736,852=1,943,017(15.3%)

This is a case in which when a policy holder does not have only disclosed-interest insurance products and a variable insurance product is included in the policy holder's insurance products unlike that described with reference to FIG. 4, a changeable insurance product with the lowest interest rate (earning rate) among the insurance products is put into annuity finances as described above with reference to FIG. 5 so that overall insurance efficiency may be improved. This is the “system for escalating an overall insurance earning rate with variable insurance” in which variable insurance completely plays its own role and also is put into annuity finances or causes other insurance to be put into annuity finances so that overall insurance efficiency may be improved to the maximum every year. Even when a policy holder has only two insurance products, the aforementioned efficiency may be expected. In this regard, when a policy holder has several variable insurance products, the annuity efficiency may be improved by 20% to 50% due to the escalating system. The escalating system may be helpful for many people who start their living on annuities with limited annuity finances to live in comfortable circumstances.

A method of using the annuity calculation program according to an exemplary embodiment of the present invention will be described below with reference to drawings.

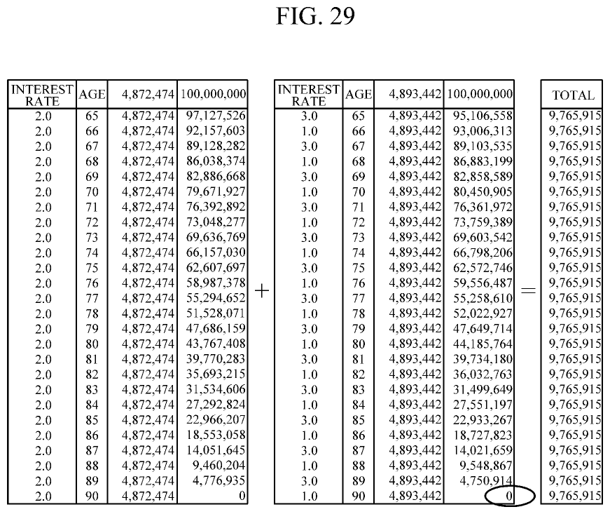

FIG. 29 shows an example in which insurance products calculated as annuities through the all-around annuity calculation program of FIG. 24 are joined together as a preparatory process according to an exemplary embodiment of the present invention.

Referring to FIG. 29, several insurance products, which are calculated as annuities through the all-around annuity calculation program described above with reference to FIG. 24, are joined together. The joining is not manually performed. Rather, the input number of insurance products are automatically joined together, and the sum of annuity receipts is also calculated and output.

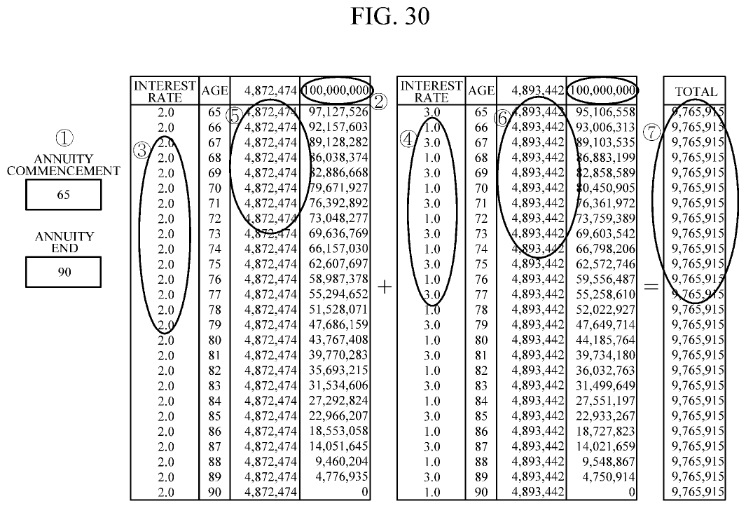

FIG. 30 shows an example of user inputs to an annuity calculation program for escalating an overall insurance earning rate according to an exemplary embodiment of the present invention.

Referring to FIG. 30, a user inputs an annuity commencement age and an annuity end age \textcircled{1}, inputs insurance-specific cancellation refunds of an annuity commencement time \textcircled{2}, inputs an interest rate of an insurance product when the insurance product is fixed-interest (earning rate) insurance \textcircled{3}, and inputs earning rates which vary depending on year one by one from the first year in which an insurance product is variable insurance \textcircled{4}.

In the case of fixed-interest insurance, annuity receipts are directly calculated according to the fixed interest rate \textcircled{5}.

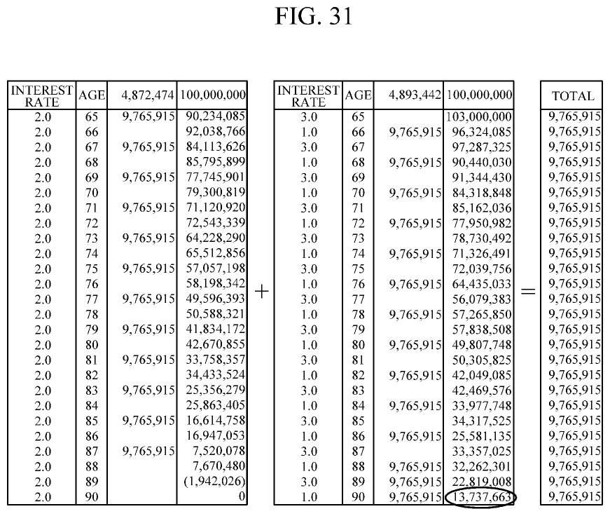

In the case of variable insurance, earning rates are not automatically input from the first year to the last year unlike fixed-interest insurance, and the user inputs earning rates of the first year to the end one by one from the first year. An earning rate of variable insurance corresponding to a year is calculated as “a cancellation refund reported by an insurance company in the last year/a cancellation refund reported by the insurance company in the year before last year” in consideration of interim payments. Subsequently, as shown in FIG. 31, annuities for escalating an overall insurance earning rate are calculated.

FIG. 31 illustrates the annuity calculation method for escalating an overall insurance earning rate according to an exemplary embodiment of the present invention.

Referring to FIG. 31,

(1) In the 0^{th} year of annuity commencement:

the following values are input to a starting interest rate (earning rate) of each product.

\textcircled{1} Disclosed-interest insurance: the average of the lowest interest rate and the disclosed interest rate of the corresponding year (the lowest interest rate of a product without a minimum interest rate is considered to be 0%)

\textcircled{2} Variable insurance: Since management results and a cancellation refund of variable insurance are reported by an insurance company at the end of each year, the data is used. In this case, when the total amount of payments is amount paid (ap), a payment end age is age1 (a1), an annuity commencement age is age2 (a2), and a cancellation refund reported by the insurance company at the end of the year before annuity commencement (=annuity commencement finances) is accumulated money (am), an expected starting interest rate (earning rate) is

$${\frac{am}{ap}}^{( \frac{1}{a 2 - a 1} )} - 1.$$

(2) In the first year of annuity commencement (first year of annuitant living):

The following values are input to a first-year interest rate (earning rate) of each product.

\textcircled{1} Disclosed-interest insurance: the average of the lowest interest rate and the disclosed interest rate of the corresponding year

\textcircled{2} Variable insurance: an earning rate of the 0^{th} year of annuity commencement

$${\frac{am}{ap}}^{( \frac{1}{a 2 - a 1} )} - 1$$

In this case, interim payments for the first year of annuity commencement are withdrawn from a product with a lower one of input interest rates (earning rates). A principal and interest of the other product are accumulated at the corresponding interest rate during the single year.

(3) In the second year of annuity commencement (second year of annuitant living):

\textcircled{1} Disclosed-interest insurance: the average of the lowest interest rate and the disclosed interest rate of the corresponding year

\textcircled{2} Variable insurance:

Cancellation refund reported at the end of the last year: a

Cancellation refund reported at the end of the year before last year: b

Earning rate of variable insurance from which no interim payment p has been made in the corresponding year=(a/b)−1

Earning rate of variable insurance from which any interim payment p has been made in the corresponding year=((a+p)/b)−1

In this case, interim payments for the second year of annuity commencement are withdrawn from a product with a lower one of input interest rates (earning rates). A principal and interest of the other product are accumulated at the corresponding interest rate during the single year.

(4) In the third year of annuity commencement (third year of annuitant living)

This is the same as (3) the second year of annuity commencement and is continuously repeated thereafter.

(5) Advent of product whose remainder is less than an annuity amount for one year

The annuitant living continuously proceeds with the other product alone, and the product whose remainder is less than an annuity amount for one year is left untouched and added to the other product for settlement at the annuity end.

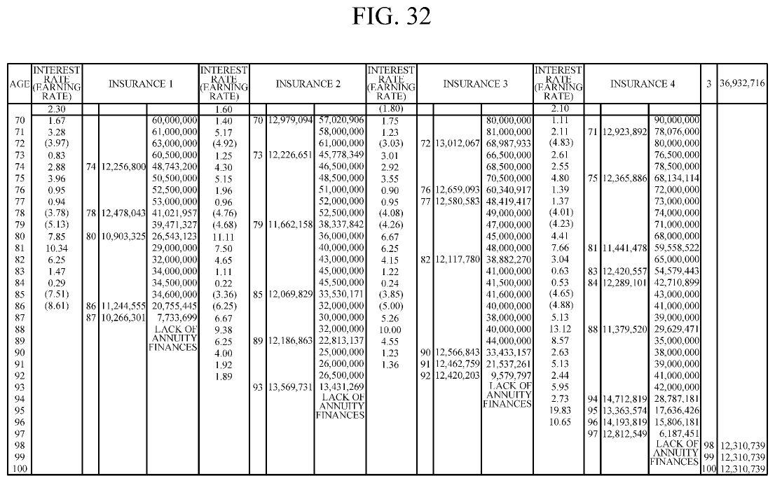

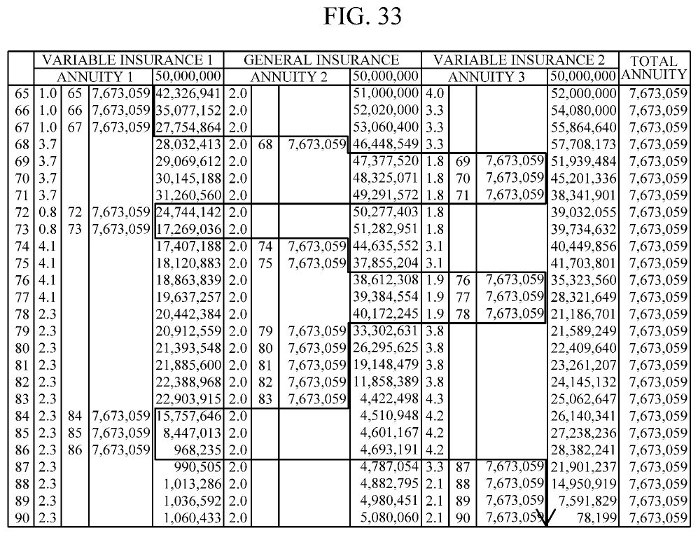

FIGS. 32 and 33 show annuity calculation screens of the annuity calculation program for escalating a whole insurance earning rate according to an exemplary embodiment of the present invention.

Specifically, FIGS. 32 and 33 show examples of calculating annuities through sequential arrangements, in which an insurance product with the lowest earning rate is put into annuity finances when a policy holder has four variable insurance products and a policy holder has two general insurance products and two variable insurance products, respectively. As shown in FIG. 33, a sequential arrangement is made downward in a stair shape from the annuity commencement year to the annuity end year.

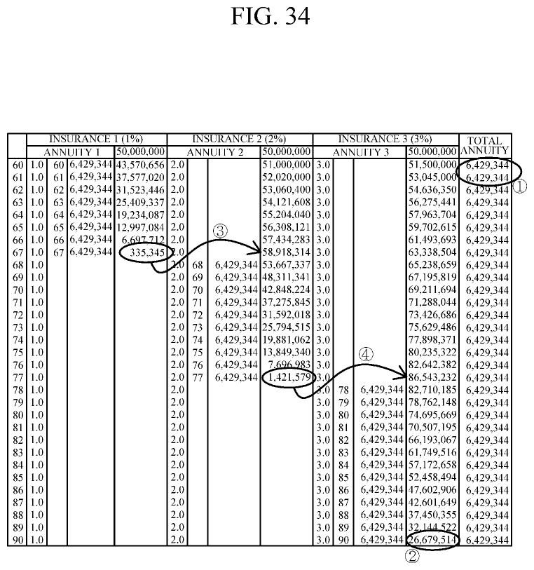

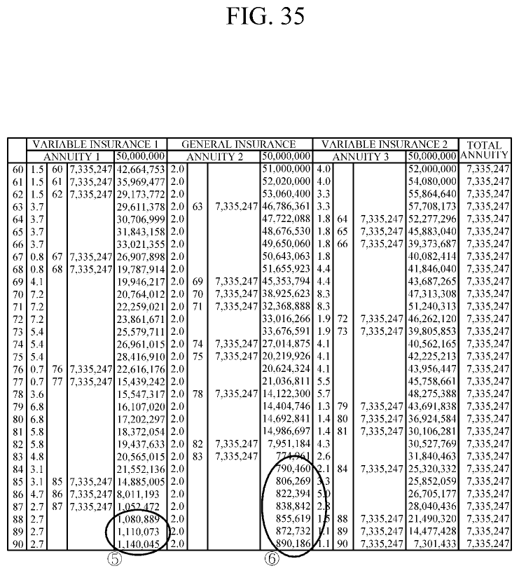

FIGS. 34 and 35 show program screens illustrating a remainder processing method of the annuity calculation program for escalating a whole insurance earning rate according to an exemplary embodiment of the present invention.

Actually, in the case of variable insurance, a value input to an earning rate of the present year is not the earning rate of the present year but an earning rate of the last year. Strictly speaking, there is no earning rate of the present year in the case of variable insurance. This is because it is possible to know an earning rate of the present year at the end of the present year. Therefore, an earning rate of the present year is expected to be about an earning rate of the last year.

FIGS. 34 and 35 have different lower parts because of the following reason.

When insurance products of a policy holder are fixed-interest insurance as shown in FIG. 34, a final remainder of insurance 1 (annuity 1) which is less than an annuity amount for one year is added to the next insurance (insurance 2 (annuity 2)) \textcircled{3} immediately before the next insurance (insurance 2 (annuity 2)) is converted into an annuity. Also, a final remainder of insurance 2 (annuity 2) which is less than an annuity amount for one year is added to insurance 3 (annuity 3) \textcircled{4} immediately before insurance 3 (annuity 3) is converted into an annuity. In other words, a remainder of a previous insurance product is added to a current insurance product. In this case, the previous insurance product ends when the remainder of the previous insurance product is transferred to the current insurance product.

When a variable insurance product is included in insurance products of a policy holder as shown in FIG. 35, a method of processing a remainder differs from the method of FIG. 34. A remainder is not transferred to a next insurance product (i.e., the corresponding product does not end) but remains \textcircled{5} because the corresponding product is variable insurance. Variable insurance has a chance of a remarkably high earning rate someday in the future. In this regard, it is necessary to leave variable insurance for additional investment. This is because occasionally variable insurance makes an earning rate of tens of percent. Therefore, unlike the disclosed-interest insurance described above with reference to FIG. 34, the variable insurance product does not end by transferring a final remainder to a next product, and the remainder is left.

Assuming that the variable insurance product ends because of the small remainder, the policy holder may regret having ended the insurance product upon seeing a sharp rise in the profit of the variable insurance product in the future. For this reason, it is necessary to not end all variable insurance products and to leave the final remainder thereof to the end, unlike the disclosed-interest insurance of FIG. 34. When a high earning rate is made, it is efficient to put all of several remainders into the corresponding variable insurance product and end the variable insurance product after the annuitant living. A remainder of a product is left \textcircled{6} together even though the product is not variable insurance. This is intended to additionally put the remainder into the variable insurance product \textcircled{5} when the variable insurance product \textcircled{5} recovers and makes a high earning rate in the future.

Consequently, when a policy holder has disclosed-interest insurance only as shown in FIG. 34, the policy holder does not regret ending a previous product, and thus a remainder of the previous product is transferred to a next product. This is because the next product has an earning rate which is even slightly higher than that of the previous product. On the other hand, when variable insurance is included, respective remainders are unused and processed at the end as described above.

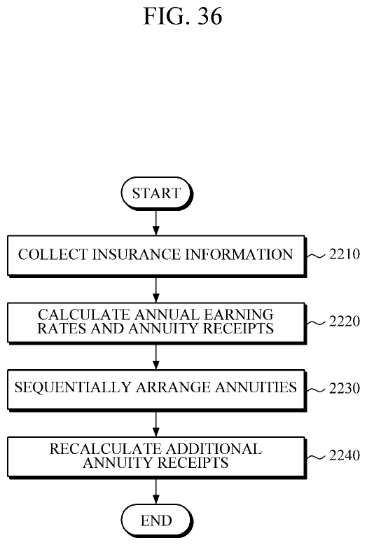

FIG. 36 is a flowchart showing a process of escalating a whole insurance earning rate with variable insurance according to an exemplary embodiment of the present invention.

Referring to FIG. 36, in the method of escalating a whole insurance earning rate with variable insurance, the annuity calculation program collects insurance information of a policy holder who has a plurality of insurance products, including at least one variable insurance product, and wants to live on annuities through interim payments (2210).

Then, the annuity calculation program calculates annual earning rates of each insurance product using the collected insurance information and calculates possible annuity receipts based on the earning rates (2220).

Subsequently, the annuity calculation program sequentially arranges annuities in a manner in which an insurance product with the lowest earning rate among the insurance products whose earning rates have been calculated is put into annuity finances every year starting from an annuity commencement until an annuity end, and other insurance products are left untouched during the corresponding time period (2230).

Additionally, the annuity calculation program may recalculate additional annuity receipts so that a final remainder left behind in the sequential arrangement operation may be additionally received as annuities (2240).

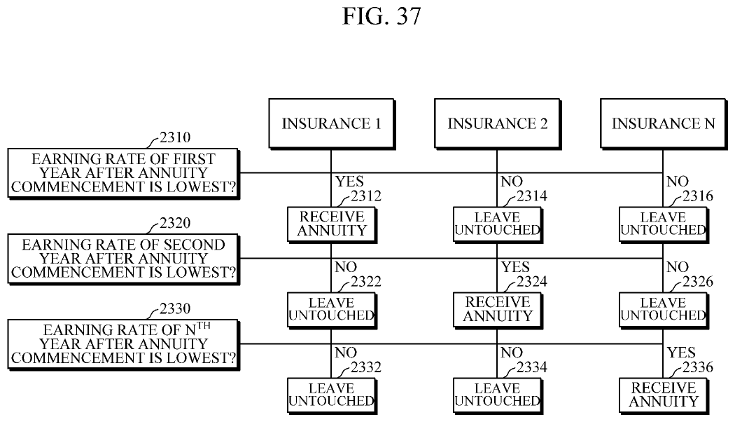

FIG. 37 is a diagram showing a sequential arrangement process of FIG. 36 according to an exemplary embodiment of the present invention.

Referring to FIGS. 36 and 37, when the policy holder has n insurance products including variable insurance, the annuity calculation program for escalating a whole insurance earning rate compares earning rates of the insurance products corresponding to the first year after annuity commencement and determines an insurance product with the lowest earning rate (2310). At this time, assuming that the insurance product with the lowest earning rate is insurance 1, the annuity calculation program causes the policy holder to receive an annuity from insurance 1 (2312) and leaves insurance 2, . . . , and insurance n untouched (2314 and 2316).

Subsequently, in the same way, the annuity calculation program compares earning rates of the insurance products corresponding to the second year after annuity commencement and determines an insurance product with the lowest earning rate (2320). At this time, assuming that the insurance product with the lowest earning rate is insurance 2, the annuity calculation program causes the policy holder to receive an annuity from insurance 2 (2324) and leaves insurance 1, insurance 3, . . . , and insurance n untouched (2322 and 2326).

In the same way, the annuity calculation program determines an insurance product with the lowest earning rate until the n^{th} year after annuity commencement, which is the annuity end year (2330). At this time, assuming that the insurance product with the lowest earning rate is insurance n, the annuity calculation program causes the policy holder to receive an annuity from insurance n (2326) and leaves insurance 1, insurance 2, . . . , and insurance n−1 untouched (2332 and 2334). In this sequential method, it is possible to live on annuities with the maximum efficiency until the end.

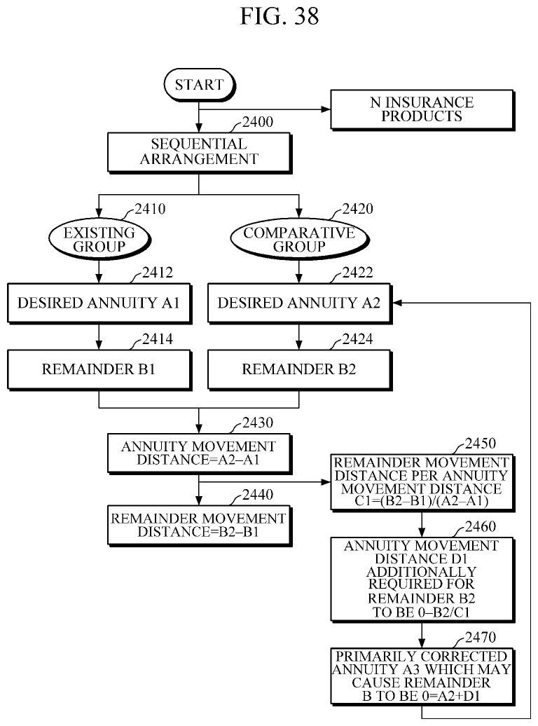

FIG. 38 is a flowchart showing a process of recalculating additional annuity receipts according to an exemplary embodiment of the present invention so that a final remainder left behind sequential arrangement may be additionally received as annuities.

Referring to FIGS. 36 and 38, the annuity calculation program for escalating a whole insurance earning rate sequentially arranges insurance products (2400) and then recalculates additional annuity receipts so that a final remainder left behind in the sequential arrangement operation may be additionally received as annuities.

For example, when a desired annuity of an existing group 2410 is a1 2412, a remainder of the existing group 2410 is b1 2414 and a desired annuity of a comparative group 2420 is a2 2422, and a remainder of the comparative group 2420 is b2 2424 as shown in FIG. 38, the annuity calculation program calculates an annuity movement distance and a remainder movement distance (2430 and 2440). Here, the annuity movement distance=the comparative-group annuity a2−the existing-group annuity a1, and the remainder movement distance=the comparative-group remainder b2−the existing-group remainder b1.

Subsequently, the annuity calculation program calculates a remainder movement distance per annuity movement distance c1 (2450). The remainder movement distance per annuity movement distance c1 equals (b1−b1)/(a2−a1). Also, the annuity calculation program calculates an annuity movement distance d1 required for the comparative-group remainder b2 to be 0 (2460). Here, the annuity movement distance d1 equals b2/c1. Subsequently, the annuity calculation program calculates a primarily corrected comparative-group annuity a3 which may cause the comparative-group remainder b2 to be 0 and equals a2+d1 (2470). Here, the annuity calculation program calculates annuity receipts that may be additionally received in a manner in which the primarily corrected comparative-group annuity a3 is input to a position of the comparative-group annuity a2 and circulates.

In the system and method for escalating an overall insurance earning rate with variable insurance according to exemplary embodiments of the present invention, the volatility of earning rate of variable insurance and the sequential function are combined together to create a new synergy so that variable insurance escalates an overall insurance earning rate. For example, in a year in which the earning rate of a variable insurance product is low, the variable insurance product is put into annuity finances, and other insurance products whose earning rates or interest rates are higher than the earning rate of the variable insurance product are left untouched and accumulated during the time period. On the other hand, in a year in which the earning rate of the variable insurance product is high, the variable insurance product is left untouched and accumulated, and other insurance products whose earning rates are lower than the earning rate of the variable insurance product are put into annuity finances. Accordingly, it is possible to live on annuities until the end with the maximum efficiency of insurance including other insurance products as well as the variable insurance product.

Such an escalating system may satisfy everyone among a customer, an insurance company, and an insurance salesman and provide a new variable insurance sales technique for attracting a customer to variable insurance even when an earning rate of the variable insurance is 0%. When an insurance company or an insurance salesman sells variable insurance to a customer, the company or salesman exaggerates an earning rate of the variable insurance with an expected earning rate in some cases. This results in many civil petitions. With the escalating system according to an exemplary embodiment, it is possible to induce a customer to imagine a synergy which will be created when the volatility of earning rate of variable insurance and the sequential function are combined together and purchase the variable insurance. In other words, it is unnecessary to tell a customer an expected earning rate, and a customer purchases variable insurance in consideration of a synergy that will be created when “the earning rate of variable insurance may increase or decrease” and the sequential function are combined together. Such a new variable insurance sales mechanism satisfies everyone among a customer, an insurance company, and an insurance salesman such that variable insurance can be sold in a totally different way than before. For this reason, the escalating system can be referred to as a new variable insurance sales system that attracts people to variable insurance even when an earning rate of the variable insurance is 0%.

Although exemplary embodiments of the present invention have been described in detail above, those of ordinary skill in the art to which the present invention pertains will appreciate that various modifications may be made without departing from the scope of the present invention. Therefore, these exemplary embodiments should be considered as illustrative rather than limiting. The scope of the present invention is to be determined by the following claims and their equivalents, and is not limited by the described exemplary embodiments.

What is claimed is:

1. A system for escalating an overall insurance earning rate with variable insurance, the system comprising:
a collector configured to collect insurance information of a policy holder who has a plurality of insurance products, including at least one variable insurance product, and wants to live on annuities through interim payments; and
a controller,
wherein the controller comprises:
an annuity calculator configured to calculate annual earning rates of each insurance product using the collected insurance information and calculate possible annuity receipts based on the earning rates; and
a sequential arranger configured to sequentially arrange annuities in a manner in which an insurance product with a lowest earning rate among the insurance products whose earning rates have been calculated is put into annuity finances every year starting from an annuity commencement until an annuity end and other insurance products are left untouched during a corresponding time period.

2. The system of claim 1, wherein the sequential arranger compares earning rates every year regardless of whether the insurance products are fixed-interest insurance or variable insurance and arranges the annuities so that a changeable insurance product with a lowest earning rate is put into annuity finances every year, and
the variable insurance product performs a variable function together with an overall insurance earning rate escalating function of improving overall insurance efficiency every year until the annuity end by putting the variable insurance product itself or another insurance product into annuity finances.

3. The system of claim 1, wherein when an insurance product is fixed-interest insurance, the annuity calculator calculates an average of a lowest interest rate and a disclosed interest rate of a corresponding year as an annuity earning rate,
when an insurance product is variable insurance, the annuity calculator calculates an expected annuity commencement earning rate by averaging interest rates of a time period between a payment end and the annuity commencement of the policy holder and calculates an expected annuity earning rate according to whether an interim payment has been made in a corresponding year from a second year after the annuity commencement, and
the annuity calculator calculates equal annuity receipts every year after the annuity commencement in consideration of a calculated earning rate of each insurance product.

4. The system of claim 3, wherein the annuity calculator calculates the expected annuity commencement earning rate of the variable insurance using an expression
$${\frac{am}{ap}}^{( \frac{1}{a 2 - a 1} )} - 1$$
(where ap is a total amount of payments, am is a cancellation refund of a year immediately before the annuity commencement, a1 is a payment end age, and a2 is an annuity commencement age) and puts the calculated expected annuity commencement earning rate into a variable insurance earning rate of a first year after the annuity commencement, and
the sequential arranger causes an interim payment to be made from an insurance product with a lowest earning rate and accumulates principals and interests of other products at corresponding interest rates during one year.

5. The system of claim 3, wherein from the second year after the annuity commencement, the annuity calculator calculates an earning rate of a variable insurance product from which no interim payment has been made in a corresponding year using an expression (a/b)−1 and calculates an earning rate of a variable insurance product from which any interim payment has been made in the corresponding year using an expression ((a+p)/b)−1 (where a is a cancellation refund reported by an insurance company at an end of a last year, b is a cancellation refund reported by the insurance company at an end of a year before last year, and p is an amount of interim payments), and
every year from the second year after the annuity commencement, the sequential arranger causes an interim payment to be made from an insurance product with a lowest earning rate and accumulates principals and interests of other products at corresponding interest rates during one year.

6. The system of claim 3, wherein the annuity calculator calculates remainders after interim payments by subtracting an annuity amount from annuity finances every year downward from an annuity commencement year to an annuity end year to create a main annuity table, calculates a final total amount of money by adding annual certain example annuities upward from the annuity end year to the annuity commencement year to create an auxiliary annuity table, and connects a main annuity equation and an auxiliary annuity equation.

7. The system of claim 6, wherein the annuity calculator calculates a remainder, which is an, after interim payments of an n^{th} year after the annuity commencement using main annuity equations an=a(n−1)×(1+r(n−1))−mn (where n is an integer greater than or equal to 2, rn is an interest rate of the n^{th} year after the annuity commencement, and mn is interim payments which will be used as an annuity of the n^{th} year after the annuity commencement) and a1=a0−m1 (where a0 is starting annuity finances), calculates a final total amount of money using auxiliary annuity equations b(n−1)=(bn+nn)/×(1+r(n−1)) (where n is an integer greater than or equal to 2, rn is an interest rate of the n^{th} year after the annuity commencement, and nn is interim payments which will be used as an annuity of the n^{th} year after the annuity commencement, and bn is a remainder after interim payments of the n^{th} year after the annuity commencement) and b0=b1+n1, and generates connection information between the main annuity equations and the auxiliary annuity equations using a connection equation mn=(a(n−1)/b(n−1))×nn (where mn is interim payments which will be used as an annuity of the n^{th} year after the annuity commencement according to the main annuity equations, an is a remainder after interim payments of the n^{th} year after the annuity commencement according to the main annuity equations, bn is a remainder after interim payments of the n^{th} year after the annuity commencement according to the auxiliary annuity equations, and nn is interim payments which will be used as an annuity of the n^{th} year after the annuity commencement according to the auxiliary annuity equations).

8. The system of claim 6, wherein when at least one of an interest rate, an amount of interim payments, and remaining annuity finances is changed, the annuity calculator recalculates new equal annuity receipts suitable for changed remaining finances every year based on the connection information between the main annuity equations and the auxiliary annuity equations.

9. The system of claim 1, wherein the sequential arranger determines, when there is an insurance product whose remainder is less than an annuity amount for one year during a sequential arrangement operation, whether the insurance product is fixed-interest insurance or variable insurance, adds the remainder to another insurance product when the insurance product is fixed-interest insurance, and sequentially arranges other insurance products and adds the remainder to another insurance product for settlement at the annuity end when the insurance product is variable insurance.

10. The system of claim 1, wherein the controller further comprises an annuity recalculator configured to recalculate additional annuity receipts so that a final remainder of a sequential arrangement operation is additionally received as annuities.

11. The system of claim 10, wherein the annuity recalculator generates a comparative group whose annuity and remainder are a1 and x1 respectively, for comparison with an existing group whose remainder and annuity are x, which is the final remainder left behind in the sequential arrangement operation, and a respectively, separately calculates an annuity movement distance, a remainder movement distance, a remainder movement distance per annuity movement distance p, an annuity movement distance q by which the comparative-group annuity a1 additionally moves so that the comparative-group remainder x1 becomes 0, and a comparative-group annuity a2 for causing the comparative-group remainder x1 to be 0, and calculates annuity receipts that are additionally received in a manner in which the comparative-group annuity a2 is input to a position of the comparative-group annuity a1 and circulates (where the annuity movement distance=the comparative-group annuity a1−the existing-group annuity a, the remainder movement distance=the comparative-group remainder x1−the existing-group remainder x, the remainder movement distance per annuity movement distance p=(x1−x)/(a1−a), the annuity movement distance q by which the comparative-group annuity a1 additionally moves so that the comparative-group remainder x1 becomes 0=the comparative-group remainder x1/the remainder movement distance per annuity movement distance p, and a corrected annuity a1(a2), which may cause the comparative-group remainder x1 to be 0, equals a1+q.
